(19) United States
(12) Patent Application Publication
(10) Pub. No.: US 2007/0160474 A1
(43) Pub. Date: Jul. 12, 2007

(54) Regulation structure, separation device and gradient forming device, and microchip using the same

(76) Inventor: Kazuhiro Iida, Tokyo (JP)

Correspondence Address: DICKSTEIN SHAPIRO LLP, 1177 AVENUE OF THE AMERICAS (6TH AVENUE), NEW YORK, NY, 10036-2714, US

(21) Appl. No.: 10/597,742

(22) PCT Filed: Feb. 1, 2005
(86) PCT No.: PCT/JP05/01381

§ 371 Date: Aug. 4, 2006

(30) Foreign Application Priority Data
Feb. 6, 2004 (JP) 2004-031435

(51) Int. Cl. B64C 11/30

(52) U.S. Cl. 416/27

(57) ABSTRACT

Provided is a regulation structure (204), comprising a first flow channel (101) in which a first liquid flows, a blocking unit (104) which communicates with the first flow channel (101) and blocks the first liquid, and a second flow channel (102) introducing a second liquid to the blocking unit (104), which regulates the flow of the first liquid from the first flow channel (101) to the second flow channel (102). Also provided is a gradient forming device comprising a forward flow channel (405) in which a first composition solution flows, a backward flow channel (404) in parallel with the forward flow channel (405) in which a second composition solution flows, a barrier (406) which separates the forward flow channel (405) and the backward flow channel (404) and allows permeation at least of the specific component in the first or second composition solution.

### TECHNICAL FIELD

The present invention relates to a regulation structure, an separation device, a gradient forming device, a microchip using the same, and others.

### BACKGROUND ART

Recently, microchemical analysis (μ-TAS) of performing chemical operations such as pretreatment, reaction, separation, and detection of sample on a microchip is in rapid progress. Microchemical analysis allows reduction in the amount of sample used, and high-sensitivity analysis with a smaller environmental load.

As techniques enabling such analysis, there is a technique which utilizes a microchip. An attempt of introducing affinity chromatography by the method has been proposed (Patent Document 1). A filling region containing an affinity adsorbent supported on a carrier such as beads is provided in the flow channel in the device, and, when a sample containing a desirable component is introduced into the flow channel, the desirable component is adsorbed by the affinity adsorbent.

In such a configuration, after adsorption of the desirable substance on the affinity adsorbent, it is needed to recover the substance by desorption from the affinity adsorbent, and a so-called gradient solution, in which the concentration of the salt solution or organic solvent having high concentration changes over time, is often used during recovery.

FIG. 10 is a schematic view illustrating a conventional gradient forming device performing gradient formation for chromatography in a column in the normal size.

When a gradient solution is needed to be formed for column chromatography on a microchip, it was necessary to use an external device having the following configuration in conventional methods.

For example, as shown in FIG. 10(A), a solution A 302A is placed in the first container 304A and a solution B 302B in the second container 304B. The solution A is supplied by a variable pump 308A formed on the flow channel 306A of the solution A and the solution B is supplied by a variable pump 308B on the flow channel 306B of solution B, forming a mixed solution. The mixed solution is then supplied through the flow channel 312 to the microchip.

As shown in FIG. 10(B), it is possible to supply a mixed solution having a concentration gradient of a particular substance over time, by adjusting the flow rates of solutions A and B with the pumps.

Patent Document 1: Japanese Laid-open patent publication No. 2002-502597

### DISCLOSURE OF THE INVENTION

It is necessary to reduce the size of entire device to perform analysis on microchip. However, as shown in FIG. 10, an external device such as pump makes it difficult to reduce the size of the entire device.

An object of the present invention, which was made under the circumstances above, is to provide a technique which realizes a microchip allowing fine-scale analysis of sample solution, for example an separation device, a regulation structure regulating flow of fluids, and a gradient forming device applied thereto.

According to the present invention, there is provided a regulation structure including a first flow channel in which a first liquid flows, a blocking unit which communicates with the first flow channel and blocks the first liquid, and a second flow channel introducing a second liquid to the blocking unit, which regulates the flow of the first liquid from the first flow channel to the second flow channel.

In such a configuration, because of the blocking unit blocking the first liquid is included, the flow of the first liquid from the first flow channel to the second flow channel is blocked by the blocking unit, when there is no liquid in the second flow channel. It is thus possible to regulate on/off of the regulation structure by introducing a liquid into the second flow channel, and thus, to realize a regulation structure regulating flow of a liquid in the fine scale.

According to the present invention, there is provided a regulation structure including a first flow channel, a second flow channel, a communication unit communicating with these flow channels, and a blocking unit which is formed in the communication unit and blocks flow of the first liquid from the first flow channel to the second flow channel, wherein the blocking unit regulates flow of the first liquid from the first flow channel to the second flow channel when there is no liquid in the second flow channel, and allows flow between the first flow channel and the second flow channel when there is a liquid in the second flow channel.

In such a configuration, because flow of the first liquid from the first flow channel to the second flow channel is regulated when there is no liquid in the second flow channel and flow of the liquids in the first and second flow channels is allowed when there is a liquid in the second flow channel, it is possible to regulate on/off of the regulation structure by introducing a liquid into the second flow channel and thus to give a regulation structure allowing regulation of liquid flow in the fine scale.

According to the present invention, there is provided a gradient forming device including a forward flow channel in which a first composition solution flows, a backward flow channel placed in parallel with the forward flow channel in which a second composition solution flows, a first inlet unit which communicates with the forward flow channel and introduces the stock solution of the first composition solution into the forward flow channel, a second inlet unit which communicates with the backward flow channel in the downstream side of the forward flow channel and supplies the stock solution of the second composition solution into the backward flow channel, and a barrier which separates the forward and backward flow channels and allows permeation at least of the specific component in the first composition solution or the second composition solution, and a gradient solution-collecting unit which communicates with the forward flow channel in the downstream side thereof which collects the first composition solution showing concentration gradient.

In such a configuration, because of the presence of a barrier which separates the forward and backward flow channels and allows permeation at least of a particular component in the first or second composition solution, the first and second composition solutions are mixed with each other while forming countercurrent flow. It is thus possible to realize a gradient forming device producing a gradient solution at fine scale.

In the present specification, the gradient forming device means a device forming a liquid having a concentration gradient (gradient) by mixing two or more kinds of liquids different in composition. The two or more liquids are not particularly limited, and are, for example, combination of a salt solution and a buffer solution.

The configuration of the present invention is so far described, but any combination of these configurations is also included in the aspects of the present invention.

In addition, conversions the regulation structure according to the present invention into devices or separation devices using the regulation structure, a washing method of the separation device or the separation method of particular substance by using the separation device are also included in the aspects of the present invention.

Further, conversions of the gradient forming device according to the present invention into the gradient-forming method using the gradient forming device are also included in the aspects of the present invention.

Conversions of the regulation structure and the gradient forming device according to the present invention into devices or microchips in which the regulation structure and the gradient forming device is combined, an separation method or mass spectrometric system for the particular substance are also included in the aspects of the present invention.

According to the present invention, there is provided a technique of realizing a microchip allowing analysis of a sample solution at fine scale, for example an separation device, and a fluid-regulation structure and a gradient forming device applicable thereto.

### BRIEF DESCRIPTION OF THE DRAWINGS

The objects described above, other objects, the characteristics and advantages of the invention will be more apparent with reference to the preferred embodiments described below and the following drawings associated therewith.

FIG. 1 is a planar view illustrating the configuration of the regulation structure according to an embodiment of the present invention.

FIG. 2 is a planar view illustrating the configuration of the regulation structure in another embodiment of the present invention.

FIG. 3 is a planar view illustrating the main region of a regulation structure according to an embodiment of the present invention.

FIG. 4 is a view illustrating the configuration of the regulation structure according to an embodiment of the present invention as seen from a different angle.

FIG. 5 is a perspective view illustrating the configuration of the regulation structure according to an embodiment of the present invention.

FIG. 6 is a view illustrating the surface structure of a columnar body in the regulation structure according to an embodiment of the present invention.

FIG. 7 is a partial cross-sectional view illustrating the configuration of the regulation structure according to an embodiment of the present invention.

FIG. 8 is a cross-sectional view showing the procedure for forming the regulation structure according to an embodiment of the present invention.

FIG. 9 is a view illustrating an separation device having the regulation structure according to an embodiment of the present invention.

FIG. 10 is a schematic view illustrating a conventional gradient forming device forming a gradient for chromatography in a column having the normal size.

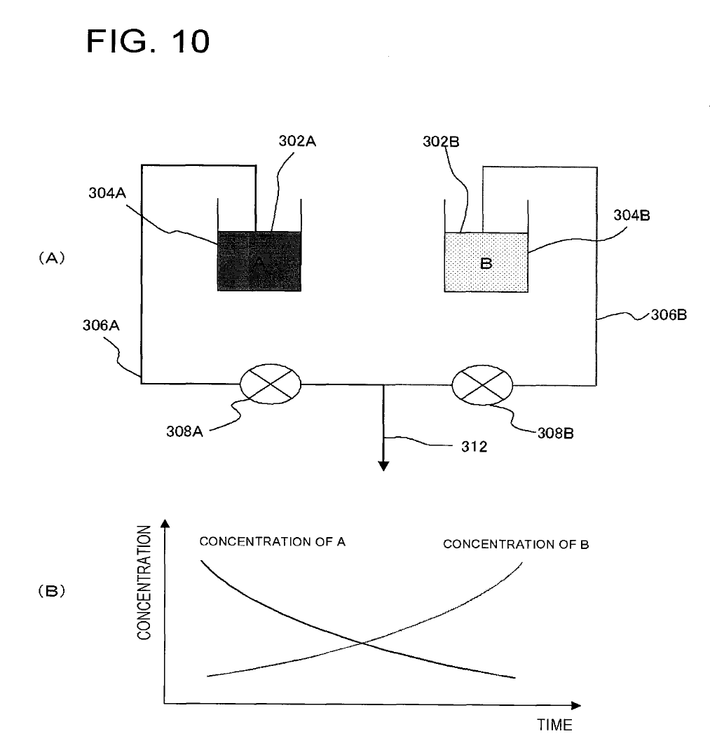

FIG. 11 is a schematic view illustrating the gradient forming device according to an embodiment of the present invention.

FIG. 12 is an expanded planar view illustrating the configuration of the barrier in the gradient forming device according to an embodiment of the present invention.

FIG. 13 is a perspective view illustrating the configuration of the barrier in the gradient forming device according to an embodiment of the present invention.

FIG. 14 is a conceptual view illustrating the mechanism of a gradient being formed in a gradient forming device according to an embodiment of the present invention.

FIG. 15 is a schematic view illustrating the microchip according to an embodiment of the present invention.

FIG. 16 is a partial cross-sectional view illustrating the configuration of the regulation structure according to an embodiment of the present invention.

FIG. 17 is a partial planar view illustrating the main region of the regulation structure according to an embodiment of the present invention.

FIG. 18 is a partial schematic view illustrating the configuration of the regulation structure according to an embodiment of the present invention.

FIG. 19 is a partial cross-sectional view illustrating the configuration of the regulation structure according to an embodiment of the present invention.

FIG. 20 is a cross-sectional view illustrating the gradient forming device according to an embodiment of the present invention.

FIG. 21 is a planar view illustrating the gradient forming device according to an embodiment of the present invention.

FIG. 22 is a schematic view illustrating the configuration of the barrier in the gradient forming device according to an embodiment of the present invention.

FIG. 23 is a schematic view illustrating the configuration of the barrier in the gradient forming device according to an embodiment of the present invention.

FIG. 24 is a view illustrating the configuration of the forward and backward flow channels in the gradient forming device according to an embodiment of the present invention.

FIG. 25 is a view illustrating the configuration of the forward and backward flow channels in the gradient forming device according to an embodiment of the present invention.

FIG. 26 is a planar view illustrating the configuration of the regulation structure according to an embodiment of the present invention.

FIG. 27 is a schematic view illustrating the configuration of the barrier in the gradient forming device according to an embodiment of the present invention.

FIG. 28 is a planar view illustrating the configuration of a liquid switch used in combination with the regulation structure or gradient forming device according to an embodiment of the present invention.

FIG. 29 is a planar view illustrating a delay device used in combination with the regulation structure or gradient forming device according to an embodiment of the present invention.

FIG. 30 is a planar view illustrating a delay device used in combination with the regulation structure or gradient forming device according to an embodiment of the present invention.

FIG. 31 is a planar view illustrating a fractionating device used in combination with the regulation structure or gradient forming device according to an embodiment of the present invention.

FIG. 32 is a planar view illustrating the configuration of a combination of the gradient forming device and the delay device according to an embodiment of the present invention.

FIG. 33 is a planer view illustrating a timing adjustment device used in combination with the regulation structure or gradient forming device according to an embodiment of the present invention.

FIG. 34 is a planar view illustrating a timing adjustment device used in combination with the regulation structure or gradient forming device according to an embodiment of the present invention.

### BEST MODE FOR CARRYING OUT THE INVENTION

In the regulation structure according to the present invention, the first and second flow channels may be placed in parallel with each other in the region close to the blocking unit. The first and second flow channels may be flow channel grooves formed on a single substrate.

The blocking unit may have a region more lyophobic to the first liquid than the first flow channel. The blocking unit may have a surface area per unit volume larger than that of the first flow channel. The blocking unit may be composed of multiple communicating flow channels formed in the barrier separating the first and second flow channels. The blocking unit may contain a porous material. The blocking unit may have one or more projections.

The first flow channel may have a first opening communicating with the external atmosphere, and the second flow channel may include a second opening communicating with the external atmosphere.

The device according to the present invention is a device having the regulation structure described above.

The separation device according to the present invention is an separation device having an separation unit which separates a particular substance in sample solution, the regulation structure above, a sample-solution inlet unit, a washing-solution inlet unit, and an inlet unit of the eluent liquid for the particular substance. The regulation structure is communicating with the separation unit via the first flow channel. The sample-solution and the washing-solution inlet units communicate with the first flow channel in the area between the regulation structure and the separation unit. The inlet unit of eluent liquid communicates with the regulation structure via the second flow channel.

The method of washing the separation device is a washing method including a step of washing the separation unit with a washing solution by introducing the washing solution into the washing-solution inlet unit and feeding the washing solution through the first flow channel.

The method of separating a particular substance by the separation device is an separation method, including a step of allowing the particular substance to be captured by the separation unit by introducing a sample solution into the sample-solution inlet unit, feeding the sample solution in the first flow channel, a step of washing the separation unit with a washing solution by introducing the washing solution into the washing-solution inlet unit and feeding the washing solution through the first flow channel, and a step of separating the particular substance from the separation unit by introducing the eluent liquid into the eluent-liquid inlet unit and feeding the eluent liquid in the first flow channel via the second flow channel and the regulation structure.

The forward and backward flow channels may be flow channel grooves formed on a single substrate. The barrier may have multiple flow channels communicating with the forward and backward flow channels. The barrier may be a membrane allowing permeation at least of the specific component to be permeated.

The gradient forming device according to the invention may additionally have a liquid switch having a blocking unit which is installed at a position downstream side of the region in contact with the barrier in the backward flow channel and blocks the second composition solution and a trigger flow channel which communicates with the backward flow channel in the blocking unit or the region downstream side thereof and with the forward flow channel in the first inlet unit or the region downstream side thereof and introduces the first composition solution to the blocking unit.

The method of forming a gradient in the gradient forming device is a gradient-forming method including a step of introducing the stock solution of second composition solution into the second inlet unit, a step of introducing the stock solution of first composition solution into the first inlet unit, and a step of collecting the first composition solution whose specific component shows concentration gradient, from the gradient solution-collecting unit.

The microchip according to the present invention is a microchip having a substrate, a separation device above formed on the substrate, and a gradient forming device formed on the substrate. The gradient forming device has a forward flow channel in which a first composition solution flows, a backward flow channel placed in parallel with the forward flow channel in which a second composition solution flows, a first inlet unit which communicates with the forward flow channel and introduces the stock solution of first composition solution into the forward flow channel, a second inlet unit which communicates with the backward flow channel in the downstream side of the forward flow channel and introduces the stock solution of second composition solution into the backward flow channel to be permeated, a barrier which separates the forward and backward flow channels and allows permeation at least of a particular component in the first or second composition solution, and a gradient solution-collecting unit which communicates with the forward flow channel in the downstream side thereof which collects the first composition solution showing concentration gradient. The gradient solution-collecting unit communicates with the eluent-liquid inlet unit in the separation device.

The method of separating the particular substance on the microchip is a separation method, including a step of allowing the particular substance to be captured by the separation unit by introducing a sample solution into the sample-solution inlet unit and feeding the sample solution in the first flow channel, and thus, a step of washing the separation unit with a washing solution by introducing the washing solution into the washing-solution inlet unit and feeding the washing solution through the first flow channel, a step of introducing the stock solution of second composition solution into the second inlet unit, a step of introducing the stock solution of first composition solution into the first inlet unit, and a step of collecting an eluent liquid of the first composition solution showing concentration gradient from the gradient solution-collecting unit, and a step of separating the particular substance from the separation unit by introducing the eluent liquid into the eluent-liquid inlet unit and feeding the eluent liquid in the first flow channel via the second flow channel and the regulation structure.

The mass spectrometric system according to the present invention is a mass spectrometric system having a separation means which separates a biological sample according to the molecule size or the property thereof, a pretreatment unit which performs pretreatments including enzyme digestion of the sample separated by the separation means, a drying unit which dries the pretreated sample, and a mass spectrometric unit which analyzes the dried sample by mass spectrometry. The separation means includes the microchip above.

Hereinafter, embodiments of the present invention will be described with reference to drawings. The same numerals are denoted to the similar elements in all drawings, and duplicated explanation is not appropriately described.

The liquid used is not limited to an aqueous solution in the present specification, and may be an organic solvent, a mixture of an organic solvent and an aqueous solution, or a liquids in which fine particles is dispersed, unless specified otherwise.

In addition, in the regulation structure or the gradient forming device described above, the flow channel may be a groove formed on a substrate. The regulation structure or the gradient forming device described above having grooves formed on the substrate surface as its flow channels shows the following operational advantages.

First, it is possible to form a flow channel in the size (width and depth) accurately controlled at a desired value. Thus, it is possible to control liquid flow at high accuracy and form a favorable gradient.

Secondly, it is possible to process the openings in the barrier formed between flow channels accurately into a desirable cross-sectional shape. For example, it is possible to form a barrier having a great number of fine pores. It is also possible to form a barrier having openings in the shape allowing easy backwashing.

Thirdly, it is possible to produce a regulation structure or a gradient forming device in the configuration superior in production stability and mass productivity. Such a configuration can be prepared by dry or wet etching, when the substrate used is, for example, glass or silicone.

When the substrate is made of a thermoplastic resin, it may be prepared by injection molding. Alternatively when the substrate is made of a heat-curing resin, it can be formed by pressurizing the resin in the state in contact with a mold having a predetermined surface irregularity.

The separation device and the gradient forming device having the regulation structure described above may be formed on an identical substrate. In such a configuration, it is possible to separate a sample adsorbed in an affinity column with a gradient solution and thus to perform multi-step processings continuously. It is thus possible to perform separation processing, which is performed so far in multiple devices, in a single device, and to improve the efficiency of the separation processing drastically.

A quartz substrate will be used as the substrate in the embodiments below, but other substrate materials such as plastic material and silicone may be used instead. Examples of the plastic materials include thermoplastic resins such as silicone resin, PMMA (polymethyl methacrylate), PET (polyethylene terephthalate), and PC (polycarbonate), and heat-curing resin such as epoxy resin. These materials are easier in molding and allow reduction of the production cost.

In the embodiments below, as a method of forming the regions such as the flow channel and reservoir on microchip, for example, a method in combination of photolithography and etching is employed when a quartz substrate is used as the substrate. Alternatively, method such as injection molding, hot embossing are employed when a plastic material is used as the substrate.

The invention will be described, taking a device in which the liquid advances in a flow channel by force by the capillary effect as an example in the embodiments below, but alternatively, the liquid may be fed by using an external force such as pump, electric field, or attractive force.

Further, in the present description, the term “selective adsorption or binding” means that only a substance to be tested is adsorbed or bound to a detection substance while other substances contained in the sample remain un adsorbed or unbound. The manner of adsorption or binding is not particularly limited, and may be physical or chemical interaction. The selective adsorption or binding will be referred to as “specific interaction” below.

### Embodiment 1

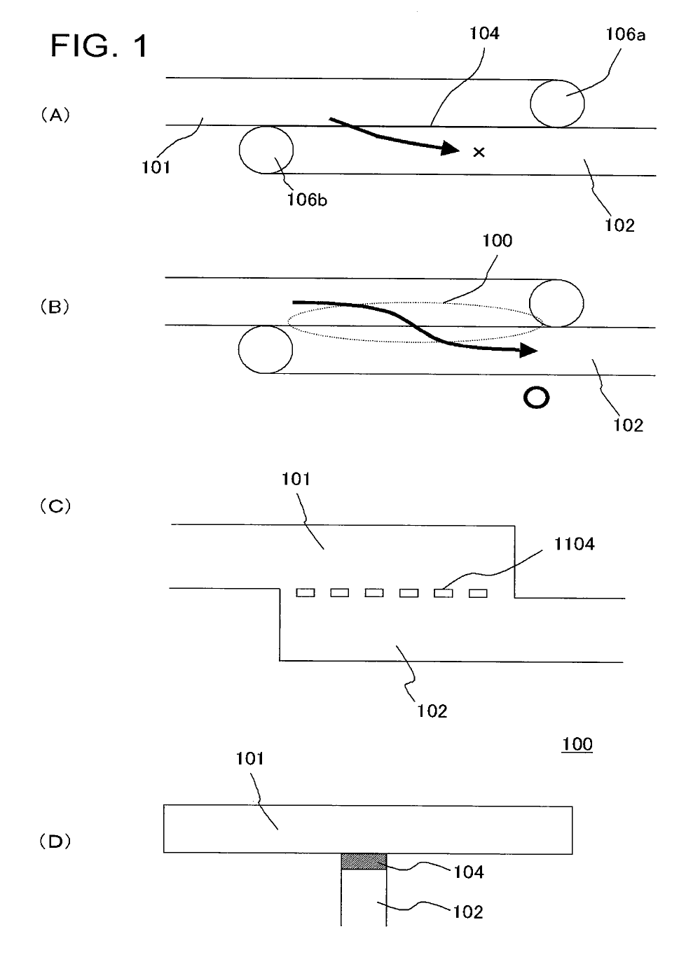

FIG. 1 is a planer view illustrating the configuration of the regulation structure according to the present embodiment.

The regulation structure according to the present embodiment is a regulation structure having a first flow channel 101 in which a first liquid flows, a blocking unit 104 which communicates with the first flow channel 101 and blocks the first liquid, a second flow channel 102 and introduces a second liquid to the blocking unit 104, regulates the flow of the first liquid from the first flow channel 101 to the second flow channel 102.

As shown in FIG. 1, the first flow channel 101 and the second flow channel 102 are placed in parallel with each other in the region close to the blocking unit 104. Thus, the first flow channel 101 and the second flow channel 102 are communicated with the blocking unit 104 through the side walls of the respective flow channels.

As shown in FIG. 1(A), the first flow channel 101 has a first opening 106a communicating with the external atmosphere, and the second flow channel 102 has a second opening 106b communicating with the external atmosphere. Each of these openings may have a cap, which may be made of a hydrophobic material.

FIG. 1(A) is a pattern view of the configuration in which the first flow channel 101 and the second flow channel 102 respectively extending in the generally opposite directions are in parallel with each other in the region close to the blocking unit 104, when the first liquid is introduced through the first flow channel 101 to the blocking unit 104. There is then no liquid introduced in the second flow channel 102, to which the first liquid is advancing.

It is possible to feed the first liquid only in one way by installing such a regulation structure. The direction of the one-way flow is determined by whether there is a solution in the second flow channel 102 in the flowing direction. The first liquid advances to the tip of the first flow channel 101 by capillary effect because the first opening 106a has an air hole but stops without entering into the second flow channel 102, by the action of the blocking unit 104 having multiple communicating flow channels formed in the barrier separating the first and second flow channels. FIG. 1(A) shows the so-called closed state of the regulation structure in the present embodiment.

The blocking unit 104 having multiple communicating flow channels formed in the barrier separating the first and second flow channels structurally has a surface area per unit volume greater than that of the first flow channel 101. The blocking effect due to the difference in the surface area per unit volume is realized based on the fact that a region having a larger surface area per unit volume is larger in wettability. According to “Wettability Technology Handbook (Yoshio Ishii, Masazumi Koisi, Mitsuo Tunoda Ed., Techno Systems Inc., p. 25-31, 2001)”, a region having a larger surface area per unit volume (hereinafter, referred to as “rough-surfaced region”) is greater in the degree of hydrophilicity and hydrophobicity than a region having smooth surface (hereinafter, referred to as “smooth-surfaced region”). For example, when there are regions different in surface area per unit volume on a hydrophilic surface, the rough-surfaced region is more hydrophilic and has a contact angle of water smaller than that of the smooth-surfaced region, and vice versa on a hydrophobic surface. As a result, when an aqueous liquid advances from a rough-surfaced region to a smooth-surfaced region, the aqueous liquid is pulled back into the rough-surfaced region and remains there at the border of the rough- and smooth-surfaced regions, and the region functions as a blocking unit. When an aqueous liquid advances into the smooth-surfaced region from a flow channel formed in the opposite side of the blocking unit, for example from a trigger flow channel, front surfaces of the liquid and the aqueous liquid fuses with each other because the liquid stops with its front surface facing to the smooth-surfaced region. Thereby the liquid permeates the border of the rough- and smooth-surfaced regions. As a result, the blocking effect disappears, and the flow channels communicate with each other.

Alternatively, the blocking unit 104 having multiple communicating flow channels formed in the barrier separating the first and second flow channels may have a surface lyophobic to the first liquid. It is based on the difference in water contact angle between hydrophilic and hydrophobic surfaces. When the front surface of an aqueous liquid which is the first liquid, advancing through a hydrophilic-surfaced flow channel reaches the boundary with a hydrophobic surface, it is pulled back into the hydrophilic region having a smaller contact angle and stops there similarly, and the region functions as a blocking unit. In the region of blocking unit where there is no hydrophobic region formed, when an aqueous liquid advances into the hydrophobic region from a flow channel formed in the opposite side of the blocking side, for example from a trigger flow channel, front surfaces of the liquid and the aqueous liquid fuses with each other because the liquid stops with its front surface projecting above the hydrophobic region. The liquid passes through the hydrophobic region. As a result, the blocking effect disappears, and the flow channels communicate with each other.

In FIG. 1(B), a second liquid is introduced previously into the second flow channel 102 in the flowing direction. When the first liquid is introduced from left into the first flow channel 101, the first liquid advances to the tip of the first flow channel 101 by capillary effect, permeates the multiple communicating flow channels in blocking unit 104 as described above, fuses with the second fluid present in the opposite side, and advances into the second flow channel 102. It is assumed that the driving force such as passing pressure applied to the first liquid is greater than that applied to the second liquid. The difference in driving force can be made, by introducing liquids so as to make the level of the reservoir for the first flow channel side higher than that of the second flow channel or that of the reservoir for the second flow channel side. Thus, FIG. 1(B) shows the so-called open state of the regulation structure in the present embodiment. With such a configuration, it is possible to make the first and second liquids advance in flow channels by capillary force without use of an external force-applying unit such as pump or electric field.

It is possible to prevent backflow of the first liquid and reduce mixing of the solutions desirably unmixed, by using the one-way flow effect. As will be described below, it is possible to prevent backflow of washing solution during washing of affinity column by using the regulation structure 104.

The regulation structure in the present embodiment 104 may be a microchip having the first flow channel 101 and the second flow channel 102 formed in the form of flow channel groove. For example, the regulation structure 104 in the present embodiment can be prepared by forming flow channels formed of grooves and the blocking units 104 in a favorable configuration on a quartz substrate surface. Generally, the surface of quartz substrate is hydrophilic, and thus, the internal wall of the groove is also hydrophilic on its surface.

The regulation structure in the present embodiment 104 in such a configuration can be formed together with other devices on a single chip. It is thus possible to reduce the size of the regulation structure in the present embodiment and the device using the same. It is also possible to produce a fine-structured regulation structure accurately by applying the microprocessing method used in the technical field of semiconductor device.

The second flow channel 102 have a structure in which the second liquid may be introduced then through the second flow channel 102 to the blocking unit 104 by a driving force applied to the second liquid such as capillary force. In such a configuration, when the second liquid is present in the second flow channel 102, the second liquid introduced to the blocking unit 104 by the driving force becomes in contact with the first liquid and permeates the regulation structure.

The driving force means a force applied in the direction pushing the first or second liquid to permeate the blocking unit 104 into the flow channel of the opposite side. The driving force is, for example, capillary force, but is not limited thereto, and may be, for example, the pressure from the liquid collected in the liquid chamber which is the rear part of flow channel, the gravitational pressure applied by inclination of the flow channel, or the pressure applied to the liquid in the flow channel by a mechanical or electricity device.

The first and second liquids may be the same as or different from each other as long as the liquids fuse with each other. For example, these liquids may be aqueous solutions or organic solvents, or alternatively, one may be an aqueous solution and the other an organic solvent.

When the first and second liquids are in contact with each other, if the driving force applied to the first liquid is greater, the first liquid permeates the blocking unit 104 into the second flow channel 102. On the contrary, when the driving force applied to the second liquid is greater, the second liquid permeates the blocking unit 104 into the first flow channel 101. It is possible to regulate the direction of the liquid flow by adjusting the intensity of the driving forces on respective fluids.

It is also possible to adjust the flow rate of the liquid in the first flow channel 101 or the second flow channel 102 by adjusting the hydrophilicity of the internal wall of flow channel, the diameter of the flow channel, and others appropriately, because it is possible to adjust the driving force in the flowing direction toward the regulation structure 104. Thus, it is possible to adjust the on/off rate of the regulation structure 104.

These flow channels may be covered with a covering material on the top. Presence of a covering material over the flow channel reduces drying of the sample liquid. When the component in sample is a substance having a high-order structure such as protein, it is possible to prevent irreversible degeneration of the component at the air-liquid interface, by closing the flow channel with a hydrophilic-surfaced covering material.

The blocking unit 104 is not particularly limited as long as it can block the first liquid, and may be in any configuration, but the blocking unit 104 preferably has, for example, a region having a lyophobicity to the first liquid higher than that of the first flow channel 101.

In such a configuration, it is possible to make force by the capillary effect in the blocking unit 104 in the direction prohibiting permeation of the first liquid into the second flow channel 102 greater than the driving force for advancing the first liquid through blocking unit 104 into the second flow channel 102, and thus, to block the first liquid in the blocking unit 104.

On the other hand, when a liquid is present in the second flow channel 102, the first and second liquids become in contact with each other, and the driving force in the blocking unit 104 prohibiting permeation of the first liquid into the second flow channel 102 disappears, is significantly reduced, or counterbalanced by the driving force applied to the second liquid, and thus, the first liquid permeates into the second flow channel 102 by the driving force applied to the first liquid.

Thus in such a configuration, it is possible to regulate on/off of the regulation structure by introducing or not feeding the second liquid into the second flow channel 102, and thus, to realize a regulation structure allowing regulation of liquid flow at fine scale.

Specifically as shown in FIG. 1(C), the blocking unit 104 may be a blocking unit 104 having multiple communicating flow channels formed in the barrier separating the first and second flow channels 1104. FIG. 1(C) is an expanded view of the region 100 around the blocking unit 104 in FIG. 1(B).

The blocking unit 104 having multiple communicating flow channels formed in the barrier 1104 separating the first and second flow channels has a surface area per unit volume larger than that of the first flow channel 101 in its configuration. The blocking unit 104 having multiple communicating flow channels formed in the barrier 1104 separating the first and second flow channels may have a surface lyophobic to the first liquid. In any case, force by the capillary effect pulling the first liquid back into the first flow channel 101 becomes greater. The blocking unit 104 having multiple communicating flow channels formed in the barrier 1104 separating the first and second flow channels can also function as a so-called filtration filter.

In such a configuration, the first liquid is blocked more easily in the blocking unit 104 when there is no second liquid in the second flow channel 102. It is also possible to expand the cross-sectional area of the blocking unit 104 relatively, when there is the second liquid in the second flow channel 102. As a result, the first liquid permeates the blocking unit 104 relatively smoothly to enter the second flow channel 102, and the flow rate of the first liquid permeating the regulation structure may be increased additionally.

As shown in FIGS. 1(A) and (B), the first flow channel 101 and the second flow channel 102 extend from opposite directions and become in parallel with each other in the region close to the blocking unit 104. When there is the second liquid in the second flow channel 102, the direction of which the first liquid advances is almost the same in the first flow channel 101 and the second flow channel 102. As a result, the first liquid permeates the blocking unit 104 relatively smoothly to enter the second flow channel 102, and the flow rate of the first liquid permeating the regulation structure may be increased further.

The first flow channel 101 and the second flow channel 102 may extend almost in the same direction and become in parallel with each other in the region close to the blocking unit 104. Alternatively, they may extend from the directions almost perpendicular to each other and cross each other as separated by the blocking unit 104. The crossing may be three-directional as shown in FIG. 1(D) or four-directional. Yet alternatively, they may extend from directions almost perpendicular to each other and bind to each other by the blocking unit 104.

Thus, the directions of extension is not particularly limited, as long as the first flow channel 101 and the second flow channel 102 communicate each other via the blocking unit 104. It is possible to regulate flow of the first liquid in the blocking unit 104 by using the regulation structure in the configuration of the present embodiment, independently of the combination of extension direction and connection form.

### Embodiment 2

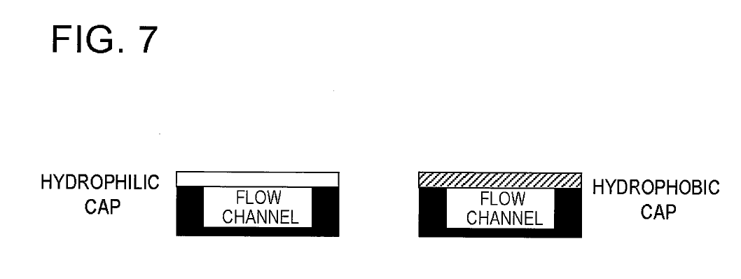

FIG. 7 is a partial cross-sectional view illustrating the configuration of the regulation structure in the present embodiment.

The regulation structure in the present embodiment is essentially the same structure as that shown in FIG. 1, except that it has a cap having a lyophobicity to the first liquid larger than that of the first flow channel in the blocking unit 104. Different from the blocking unit 104, both the first flow channel 101 and the second flow channel 102 have a lyophilic cap.

In such a configuration, force by the capillary effect in the direction pulling back the first liquid from the blocking unit 104 becomes larger. Thus, the pressure needed for feeding the first liquid through the blocking unit 104 becomes larger. When there is no liquid in the second flow channel 102, the first liquid is pushed back by the surface tension of the liquid in the blocking unit 104 and remains halfway in the blocking unit 104. As a result, it is possible to block the first liquid in the blocking unit 104.

When the first liquid is an aqueous solution, the lyophobic cap may have a hydrophobicity to the aqueous solution larger than that of the first flow channel.

Such a configuration may be prepared by forming grooves in the areas on a quartz substrate surface corresponding to the first flow channel 101, the second flow channel 102, and the blocking unit 104. The inner wall of the groove is hydrophilic on the surface, because quartz substrate is used. The blocking unit 104 including a hydrophobic region can be prepared by hydrophobilizing the cap area having a quartz glass surface.

The hydrophobilization is realized by adhering and connecting a compound having a unit adsorbing or binding to the substrate material and a unit having a hydrophobic modifying group in the molecule to the substrate surface. The compound is, for example, a silane-coupling agent or the like. Preferable examples of the silane-coupling agents having a hydrophobic group include those having a silazane binding group such as hexamethyldisilazane and those having a thiol group such as 3-thiolpropyltriethoxysilane.

For proper regulation of the hydrophobicity of blocking unit, the hydrophobilization treatment method should be properly selected, amount thereof should be optimized, or alternatively, the structure of the flow channel may be properly designated. Yet alternatively, the hydrophobicity may be regulated by forming a hydrophobic/hydrophilic pattern in which multiple hydrophobic regions are placed orderly almost at the same interval.

The method of coating the coupling agent solution or the like includes, for example, spin coating, spray coating, dip coating, gas-phase method, or the like. Spin coating refers to a method of applying a solution containing a binding-layer component such as coupling agent dissolved or dispersed therein with a spin coater. It is possible to control the thickness of film favorably by the method. Spray coating refers to a method of spraying a coupling agent solution or the like on a substrate, while dip coating refers to a method of immersing a substrate in a coupling agent solution or the like. It is possible to form a film in simple steps without need for special devices by these methods. The gas-phase method refers to a method of heating a substrate as needed and depositing a vapor of a coupling agent solution or the like thereon. It is also possible to produce a thin film with its thickness controlled favorably by the method. Among the methods above, favorably used is the method of spin coating a silane-coupling agent solution, which gives superior adhesiveness.

The concentration of the silane-coupling agent in the solution then is preferably 0.01 to 5 v/v %, more preferably 0.05 to 1 v/v %. Examples of the solvents for the silane-coupling agent solution include pure water, alcohols such as methanol, ethanol, and isopropyl alcohol, and esters such as ethyl acetate, and these solvents may be used alone or in combination of two or more. Among them, ethanol diluted with pure water, methanol, and ethyl acetate are preferable. These solvents are particularly effective in improving adhesiveness.

After application, the coupling agent solution or the like is dried. The drying temperature is not particularly limited, but usually in the range of room temperature (25° C.) to 170° C. The drying period may vary according to the temperature, but is usually 0.5 to 24 hours. Drying may be performed in air or in an inert gas such as nitrogen. For example, a nitrogen-blowing method of drying the solution while applying nitrogen steam on the substrate may be used.

Alternatively in the method of preparing the coupling agent film, it is possible to form a hydrophilic/hydrophobic micropattern by forming a membrane of silane-coupling agent over the entire substrate by the LB membrane-withdrawing method, as described in “Nature, vol. 403, 13, Jan. (2000)”.

Yet alternatively, the hydrophobilization treatment may be performed by a printing method such as stamping or inkjet printing.

A PDMS (polydimethylsiloxane) resin is used in the stamping method. The PDMS resin is resinified by polymerization of silicone oil filled and still contains the silicone oil in the intermolecular space even after resinification. Thus, when the PDMS resin is brought into contact with a hydrophilic surface, for example glass surface, the region in contact becomes strongly hydrophobic, repelling water. It is possible to produce a blocking unit formed in the hydrophobilized flow channel described above easily by using the phenomenon, that is, by bringing a PDMS block having grooves at the positions corresponding to the flow channels into contact with a hydrophilic substrate as a stamp.

In the inkjet-printing method, it is possible to obtain the same effect by using a low-viscosity silicone oil as inkjet-printing ink and ejecting the silicone oil in a pattern in which the silicone oil is applied on the wall part corresponding to the blocking units in flow channel.

### Embodiment 3

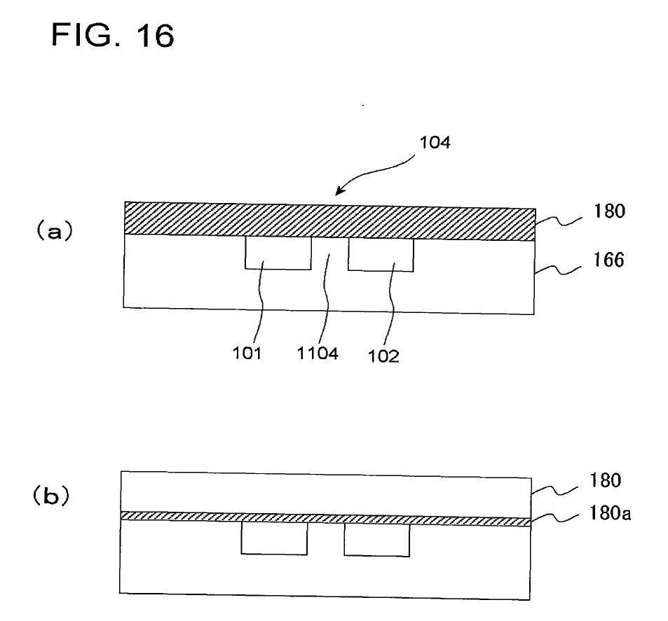

FIGS. 16(a) and (b) are partial cross-sectional views illustrating the configuration of the regulation structure in the present embodiment.

The regulation structure in the present embodiment is essentially the same structure as that shown in FIG. 1, except that the blocking unit 104 has multiple communicating flow channels formed in the barrier 1104 separating the first and second flow channels and additionally, a lyophobic cap 180 having a lyophobicity to the first liquid higher than that of the first flow channel.

Although not shown in FIG. 16, different from the blocking unit 104, both the first flow channel 101 and the second flow channel 102 both have a lyophilic cap. The surface of the substrate 166 having the first flow channel 101 and the second flow channel 102 formed is also lyophilic.

In such a configuration, the first liquid is blocked in the blocking unit 104 as described above, when there is no liquid in the second flow channel 102.

When the first liquid is an aqueous solution, the lyophobic cap may be a cap having a hydrophobicity to the aqueous solution higher than that of the first flow channel. The surface of the substrate 166 on which the first flow channel 101 and the second flow channel 102 are formed may also be hydrophilic.

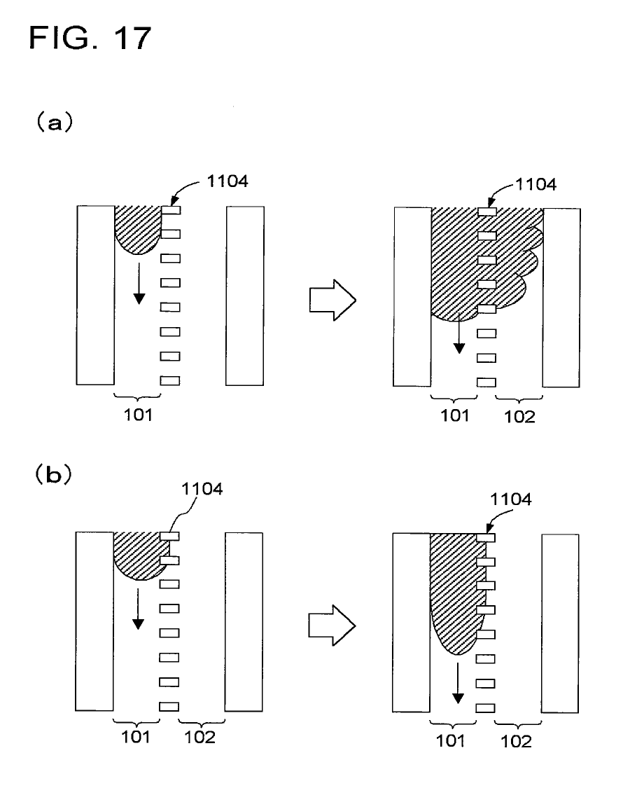

FIG. 17 is a partial planar view illustrating an example of the main part of the regulation structure in the present embodiment.

When a cap made of a hydrophilic material is used as shown in FIG. 16(a), the aqueous solution introduced into the first flow channel 101 may permeate a number of openings formed in the barrier 1104 into the second flow channel 102 rapidly, if the openings formed in the barrier 1104 are too wide in diameter. It is effective to narrow the openings to block the aqueous solution in the barrier 1104 region. However, if the opening is narrowed excessively, the liquid flow rate through the regulation structure when the regulation structure is in the open state may also be lowered excessively.

The present inventors have found that the following phenomenon occurs in the regulation structure having a cap 180 made of a hydrophobic material. That is, in FIG. 17(b), an aqueous solution introduced into the first flow channel 101 remains in the first flow channel 101 without permeation into the second flow channel 102, even when the openings in the form of barrier 1104 are as wide as those shown in FIG. 17(a). In addition, when another aqueous solution is fed through the second flow channel 102 in that state, the liquids in the first flow channel 101 and the second flow channel 102 become in contact with each other through the openings formed in the barrier 1104. As a result, the regulation structure becomes in the open state, allowing permeation of the aqueous solution in the first flow channel 101 into the second flow channel 102.

In the regulation structure in the configuration above, which has a hydrophobic cover 180 in the upper part of the regulation structure (FIG. 16(a)), it is possible to block the aqueous solution in the first flow channel 101, even with a barrier 1104 having many openings wider to some extent. It is thus possible to increase the flow rate of the aqueous solution passing through the regulation structure, when it is in the open state.

Examples of the materials for the hydrophobic cover 180 include hydrophobic resins such as polydimethylsiloxane (PDMS), polycarbonate, and polystyrene, and the like. In addition to the cover of hydrophobic material 180, for example as shown in FIG. 16(b), a cover 180 having a hydrophobic coat layer 180a formed on the surface with a hydrophobic coating agent such as xylene silazane is also used favorably.

To make the liquid regulation, that is, blockage and flow of the liquid, possible by the openings described above, it is effective to determine the hydrophobicity of the cover 180 properly according to the diameter of the openings.

For example by using a cover 180 of PDMS extremely higher in hydrophobicity, it is possible to regulate flow to make the aqueous solution in the first flow channel 101 blocked if there is no aqueous solution in the second flow channel 102 and to make the aqueous solution in the first flow channel 101 to permeate into the second flow channel 102 if there is an aqueous solution in the second flow channel 102, even when the openings are relatively larger at a diameter of 50 μm or more.

However, even when the diameter of the openings is smaller at 1 μm or less, it is possible to prevent the aqueous solution from permeating the first flow channel 101 into the second flow channel 102, even if there is an aqueous solution in the second flow channel 102, by employing a cover 180 made of PDMS.

It is possible then to make the aqueous solution in the first flow channel 101 permeate into the second flow channel 102 if there is an aqueous solution in the second flow channel 102, by choosing polycarbonate, which is lower in hydrophobicity than PDMS, as the material for cover 180.

### Embodiment 4

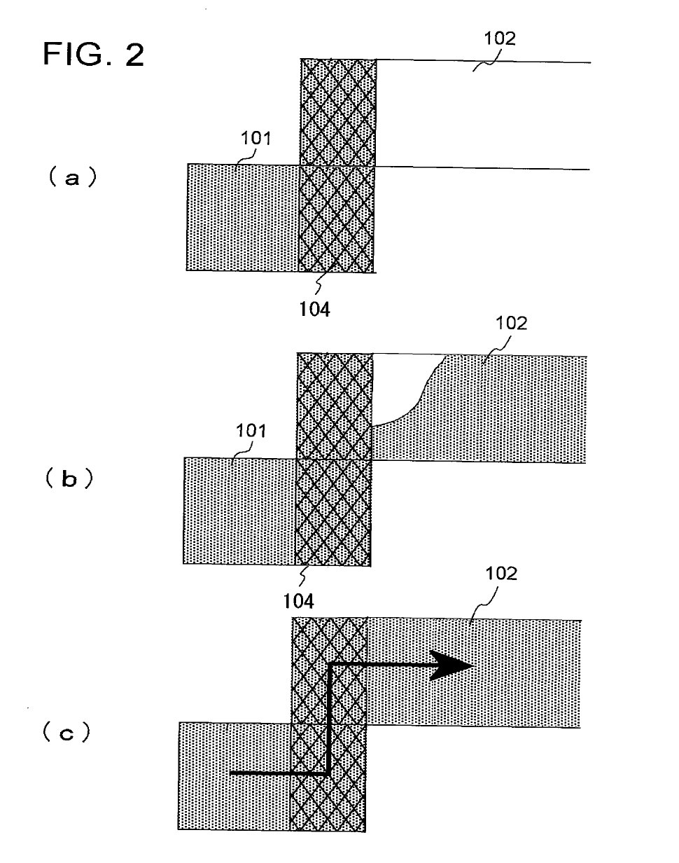

FIG. 2 is a planar view illustrating the configuration of the regulation structure in the present embodiment.

In the present embodiment, the blocking unit 104 has a surface area per unit volume larger than that of the first flow channel 101. In the following example, a porous body or beads are filled in the blocking unit 104 for adjustment of the surface area per unit volume. The blocking unit 104 may be formed by filling and bonding the porous body or beads directly in a suitable position of the flow channel.

In such a configuration, the first liquid is also blocked by the blocking unit 104, similarly as described above, when there is no liquid in the second flow channel 102.

FIG. 2(a) is a view illustrating the configuration of the present embodiment in which the first flow channel 101 and the second flow channel 102 extending from the directions almost opposite to each other become almost in parallel in the region close to the blocking unit 104, when the first liquid is introduced into the first flow channel 101 toward the blocking unit 104. There is no liquid then in the second flow channel 102 which is in the advancing direction of the first ligand.

As described above, it is possible to block flow of the first liquid in the blocking unit 104 by installing such a regulation structure. Flow of the first liquid into the second flow channel 102 is determined by whether there is a solution in the second flow channel 102 in the flowing direction. FIG. 2(a) shows the so-called closed state of the regulation structure in the present embodiment, and FIG. 2(B) shows the so-called open state of the regulation structure in the present embodiment.

In such a configuration too, it is possible to prevent backflow of the first liquid and mixing of the solutions undesirable to be mixed, similarly as described above. As will be described below, it is thus possible to prevent backflow of washing solution, for example during washing of affinity column, by using the regulation structure 104.

### Embodiment 5

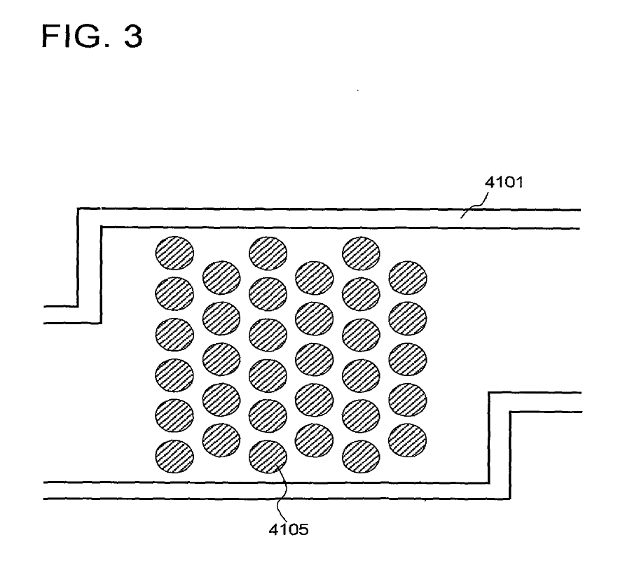

FIG. 3 is a planer view illustrating the main region of the regulation structure in the present embodiment.

In the present embodiment, the blocking unit 104 has a single or multiple projections. Specifically, the blocking unit 104 has a configuration containing multiple columnar bodies or multiple projections separated from each other. In FIG. 3, an external wall 4101 forming the flow channel and multiple columnar bodies 4105 are shown as an example of the configuration having multiple columnar bodies.

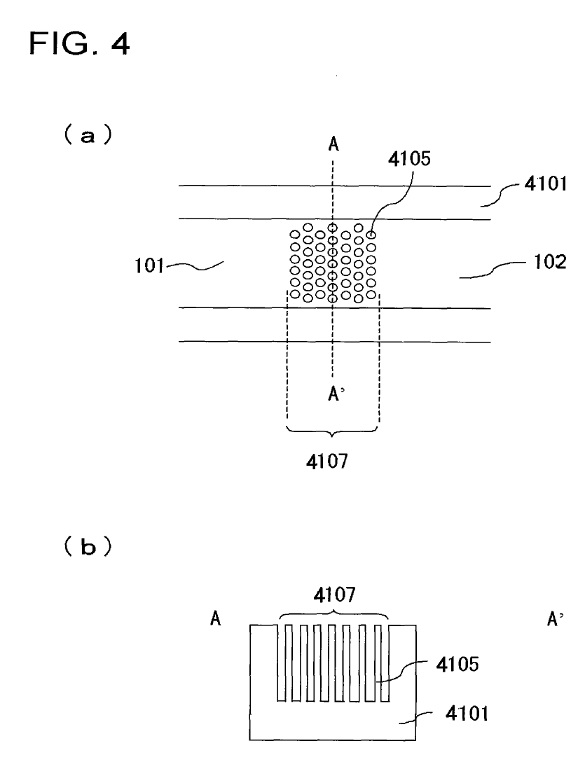

FIGS. 4(a) and (b) are views illustrating the configuration of the regulation structure in the present embodiment seen from different angles.

FIG. 4(a) is a planer view illustrating an external wall 4101 forming a flow channel, columnar bodies 4105, a first flow channel 101, a second flow channel 102, and the assembly area 4107 formed in the blocking unit 104 where columnar bodies 4105 are placed all together.

FIG. 4(b) is a cross-sectional view of the regulation structure shown in FIG. 4(a) at a line A-A′ Shown are the external wall 4101 forming a flow channel, columnar bodies 4105, and the assembly area 4107 formed in the blocking unit 104 where columnar bodies 4105 are placed all together. In the blocking unit 104, columnar bodies 4105 are installed orderly at the same interval in the flow channel, and the liquid flows through the space among the columnar bodies 4105. Alternatively, the columnar bodies 4105 may be placed at random intervals or in the state forming a patched-pattern region.

In such a configuration too, it is possible to make the solid/liquid interface in the blocking unit 104 greater than that of the other region in the flow channel. It is thus possible to increase force by the capillary effect in the direction pushing back the first liquid from the blocking unit 104 as described above, and to block the first liquid in the blocking unit 104 when there is no liquid in the second flow channel 102.

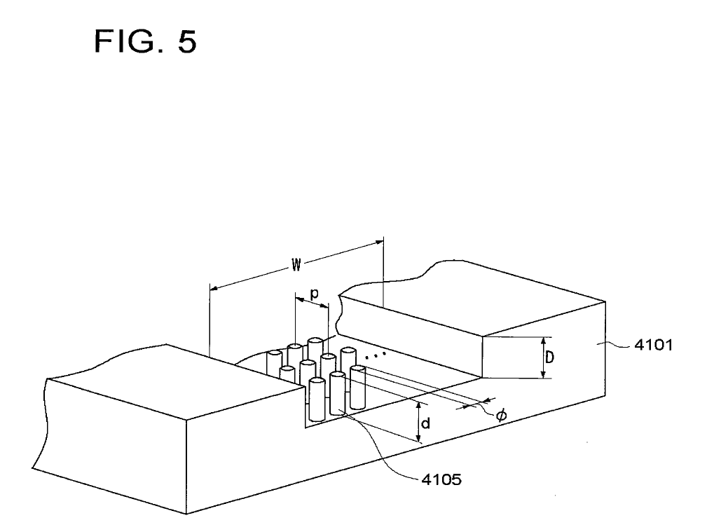

FIG. 5 is a perspective view illustrating the configuration of the regulation structure in the present embodiment. In FIG. 5, W represents the width of flow channel, Φ represents the depth of flow channel, Φ (phi) represents the diameter of columnar bodies 4105, d represents the height of columnar bodies 4105, and p represents the average interval between vicinal columnar bodies 4105. The external wall 4101 forming a flow channel is also illustrated. By adjusting these elements properly to be designed by those skilled in the art it is possible to make the solid/liquid interface in the blocking unit 104 greater than that of other regions in the flow channel. As described above, the first liquid is thus blocked in the blocking unit 104, when there is no liquid in the second flow channel 102.

Alternatively, it is possible to form a regulation structure higher in lyophobicity to the first liquid than that of the first flow channel, by lyophobilizing the surface of the single or multiple projections.

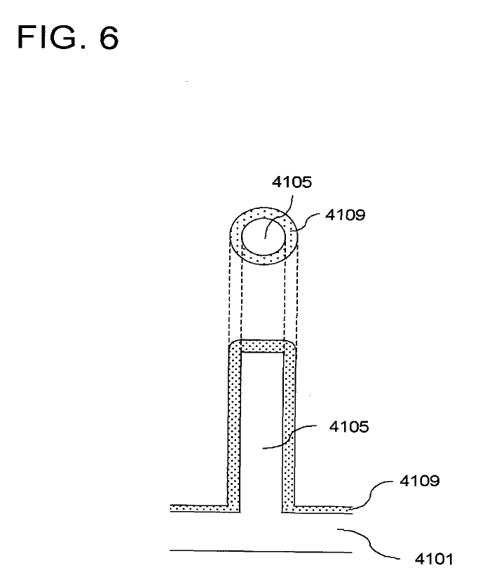

FIG. 6 is a view illustrating the surface structure of a columnar body in the regulation structure in the present embodiment. A lyophobic layer 4109 is formed on the surface of the external wall 4101 forming a flow channel and also on the columnar bodies 4105 in the blocking unit 104.

In such a configuration too, force by the capillary effect in the direction pushing back the first liquid from the blocking unit 104 is increased. Accordingly as described above, the first liquid is blocked in the blocking unit 104, when there is no liquid in the second flow channel 102.

In forming such a configuration on microchip, the blocking unit 104, for example in the configuration having multiple columnar bodies formed or multiple projections formed separated from each other, can be formed by a suitable method according to the kind of the microchip substrate.

Specifically, the blocking unit 104 is formed favorably by a photolithographic or dry etching technique, when a quartz or silicone substrate is used. When a plastic substrate is used, the blocking unit 104 in a desirable shape can be formed by preparing a mold having an inversion pattern of the pattern of the columnar body to be formed and molding in the mold. Such a mold can be prepared by using a photolithographic or dry etching technique.

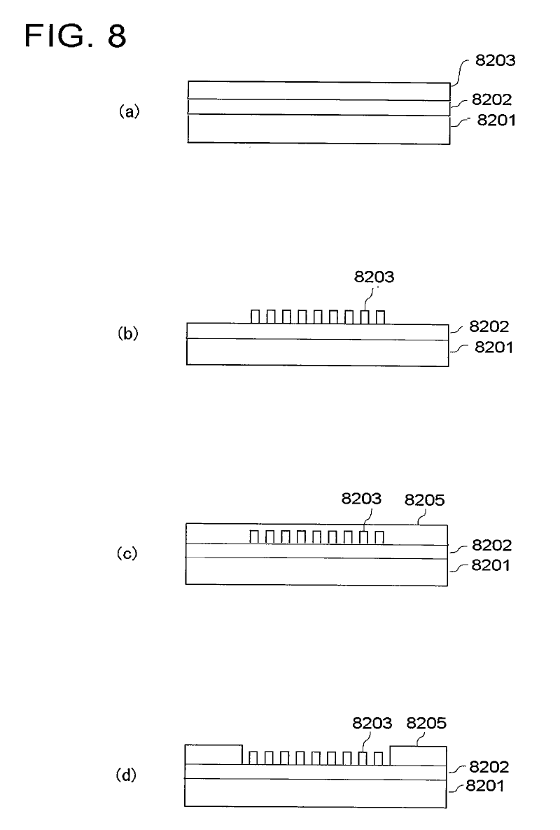

FIG. 8 includes cross-sectional views showing the procedure for forming the regulation structure in the present embodiment.

The method of producing a blocking unit having a single or multiple projections in the present embodiment will be described below.

As shown in FIG. 8(a), for example, a bottom-wall material 8202 of blocking unit and a columnar body material 8203 of blocking unit are first formed by CVD in that order on a support 8201. The thickness of the bottom-wall material layer 8202 and the columnar body material 8203 is designed properly by those skilled in the art. As shown in FIG. 8(b), the columnar body material 8203 is then patterned, for example, by a photolithographic or dry etching technique. As shown in FIG. 8(c), a side-wall material 8205 is then formed and patterned similarly as shown in FIG. 8(d). The regulation structure shown in FIG. 4(a) is formed by the process above. After the processes above, the regulation structure may be additionally surface-treated for example for making it lyophobic.

It is possible to form the regulation structure in the present embodiment at high accuracy in such process, by using a microfabrication technique commonly used in the semiconductor technical field.

### Embodiment 6

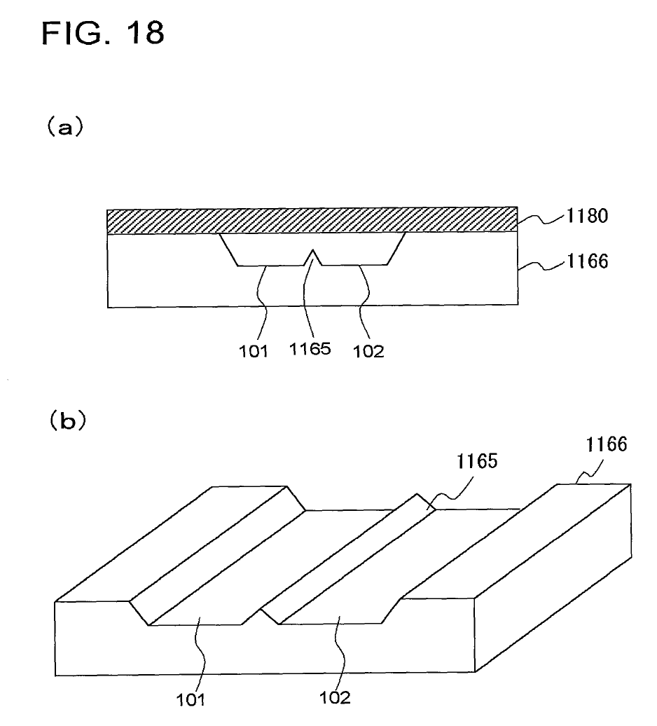

FIG. 18 is a partial schematic view illustrating the configuration of the regulation structure according to an embodiment of the present invention.

In the embodiments above, shown are the regulation structures in the configuration having a barrier formed with multiple communicating flow channels and having a single or multiple projections. In the present embodiment, shown is a regulation structure having bank-shaped configuration, which is different from them.

FIGS. 18(a) and (b) are respectively cross-sectional and perspective views thereof. As shown in FIG. 18(a), the substrate 1166 has a first flow channel 101 and a second flow channel 102, a bank unit (barrier) 1165 is formed so as to divide the channels, and the height of the bank unit 1165 is smaller than the depth of the first flow channel 101 or the second flow channel 102. A cover 1180 is placed over the substrate 1166. The cover 1180 is not shown in FIG. 18(b) for convenience.

As apparent from FIG. 18(a), there is a space between the barrier 1165 and the cover 1180, and the first flow channel 101 and the second flow channel 102 communicate with each other through the space. The space corresponds to the communicating flow channels formed in the barrier wall in the regulation structures in the embodiments above. Selection of a hydrophobic material such as polydimethylsiloxane or polycarbonate as the material for the cover 1180 is effective in such a case.

In this way, for example when a aqueous solution is fed into the first flow channel 101 and there is no other aqueous solution in the second flow channel 102, the aqueous solution in the first flow channel 101 is blocked in the bank unit 1165. When there is another aqueous solution present in the second flow channel 102, the aqueous solution in the first flow channel 101 permeates into the second flow channel 102 over the bank unit 1165.

The regulation structure in the present embodiment has a first flow channel 101 and a second flow channel 102 each having a wider area than that of those in the regulation structures in the embodiment above, and thus, has advantages that the flow rate in the open state is greater. And even rod-shaped substances can move between flow channels easily without clogging. Thus, the regulation structure is favorably used for regulation of flow of a liquid containing such a rod-shaped substance.

The first flow channel 101, second flow channel 102 and barrier 1165 are prepared, for example, by wet etching of a (100) Si substrate. When a (100) Si substrate is used, the etching progresses in the trapezoidal shape in the direction perpendicular to or parallel with the (001) direction, as shown in the drawing. It is thus possible to control the height of the barrier 1165 by adjusting the etching period.

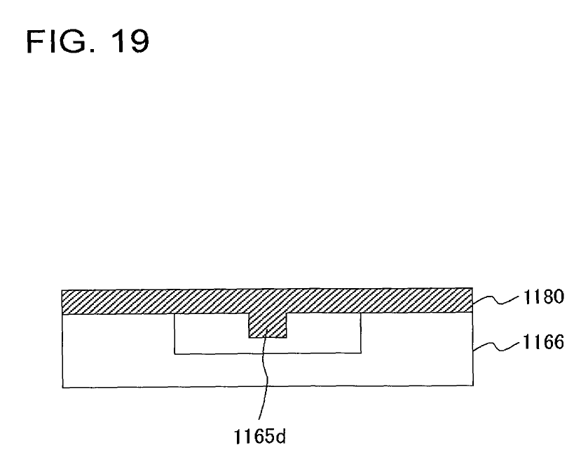

Alternatively as shown in FIG. 19, a barrier 1165d may be formed on the cover 1180. Such a cover 1180 having a barrier 1165d is easily prepared by injection molding of a resin such as polystyrene. In addition, only one flow channel is formed on the substrate 1166, for example, by etching. Accordingly, such a separation device, which can be prepared in the simple process described above, is suitable for mass production.

### Embodiment 7

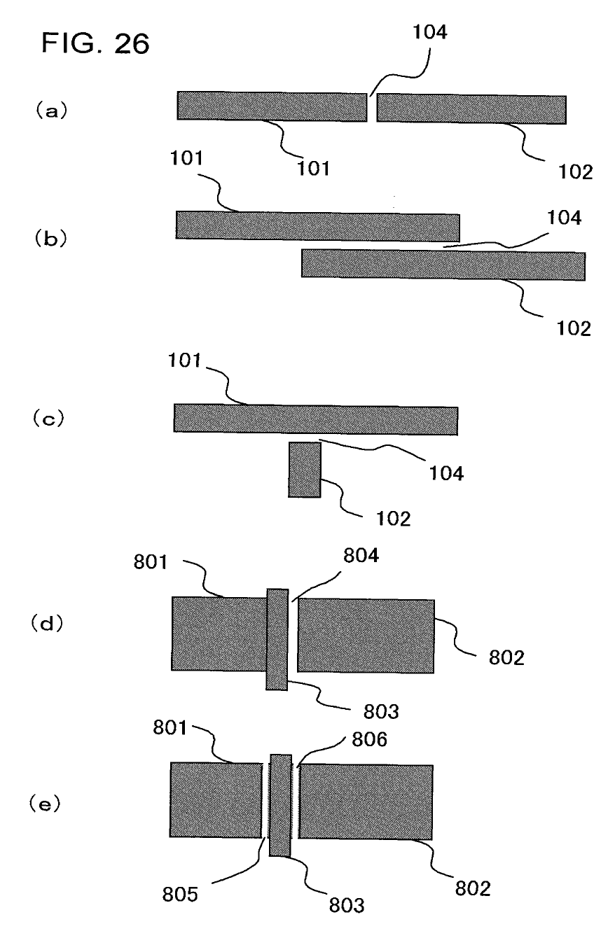

FIG. 26 is a schematic view illustrating the configuration of the regulation structure according to an embodiment of the present invention.

The regulation valve in the present embodiment can be prepared by applying a photolithographic technique. Specifically, the regulation valve according to the present embodiment can be prepared by applying a highly hydrophobic photoresist, a photocuring resin, or the like on a highly hydrophilic substrate such as slide glass and forming a pattern similar to that shown in FIG. 26(a), 26(b), or 26(c).

Such photoresist is, for example, Microposit® S1805 photoresist (manufactured by Shipley Company, Inc.).

The contact angle of water droplet on the S1805 surface is approximately 80 degrees, and the contact angle of water droplet on the glass substrate surface without coating of S1805 (or S1805-deleted glass substrate surface) is approximately 40 degrees. It is thus possible to obtain a hydrophilicity-hydrophobicity difference sufficient for making the regulation valve in the present embodiment exhibit its function.

FIGS. 26(a), 26(b), and 26(c) are schematic planar views illustrating the regulation structures in the present embodiment. In these drawings, the shaded regions are hydrophilic regions (S1805-nonapplied or S1805-deleted glass substrate surfaces) which forms a flow channel for aqueous solution. The blank regions are hydrophobic regions (S1805-applied surface) which forms the outer wall of the flow channel for aqueous solution, the blocking unit, and the like.

These regulation structures are those having a first flow channel 101 in which an aqueous solution flows, a blocking unit 104 which communicates the first flow channel 101 and blocks the aqueous solution, and a second flow channel 102 which introduces another aqueous solution to the blocking unit 104. These regulation structures regulates the flow of the aqueous solution from the first flow channel 101 to the second flow channel 102. The blocking unit 104 has a region having a hydrophobicity to the aqueous solution higher than that of the first flow channel 101.

Similarly as described above, in such a configuration, the aqueous solution (first liquid) is blocked in the blocking unit 104, when there is no other aqueous solution in the second flow channel 102.

Specifically, the two flow channels in the regulation structure in the present embodiment is separated by a narrow hydrophobic region, as shown in FIGS. 26(a), 26(b), and 26(c). The width of the hydrophobic region is made so narrow that the menisci of the aqueous solutions overhanging from the flow channels on both sides fuse to each other.

When an aqueous solution is introduced into only one of the two flow channels, the aqueous solution is stops in the hydrophobic region. On the other hand, if there is an aqueous solution in the opposite flow channel, the menisci of both aqueous solutions fuse to each other, allowing the two flow channels to communicate.

The liquid switch described below for use in the gradient forming device in the present embodiment can also be prepared in a similar manner to the regulation valve in the present embodiment by applying a photolithographic technique.

Specifically, the liquid switch can be prepared by applying a highly hydrophobic photoresist, a photocuring resin, or the like on a highly hydrophilic substrate such as slide glass and forming a pattern shown in FIGS. 26(d) or 26(e).

As shown in FIG. 26(d) in the liquid switch, main flow channels extending horizontally (consisting of the first flow channel 801 and the second flow channel 802) and a trigger flow channel 803 extending vertically cross each other, and a blocking unit 804 of hydrophobic region is formed to one side of the trigger flow channel 803, separating the main flow channels.

In such a configuration, when an aqueous solution is introduced into the first flow channel 101 and there is an aqueous solution in the trigger flow channel 803, the menisci of the aqueous solutions fuse to each other, allowing the main flow channels to communicate with each other.

Alternatively as shown in FIG. 26(e), the liquid switch may have a first blocking unit 805 and a second blocking unit 806 made of hydrophobic region formed to both sides of the trigger flow channel 803.

In such a configuration, the liquid switch shown in FIGS. 26(d) and (e) has the function of the regulation structure in the present embodiment. When an aqueous solution is introduced into the first flow channel 801, the main flow channel opens only if there are aqueous solutions in the trigger flow channel 803 and the opposing second flow channel 802.

These planar structures are structured for processing of aqueous solutions, but the regulation structure in the present embodiment is not particularly limited to regulation of aqueous solutions. If the first liquid is made of, for example, an oily solvent, it is possible to obtain a similar advantageous effect by replacing the hydrophilic region in the planar structures above with a lipophilicity region and the hydrophobic region with a lipophobic region.

### Embodiment 8

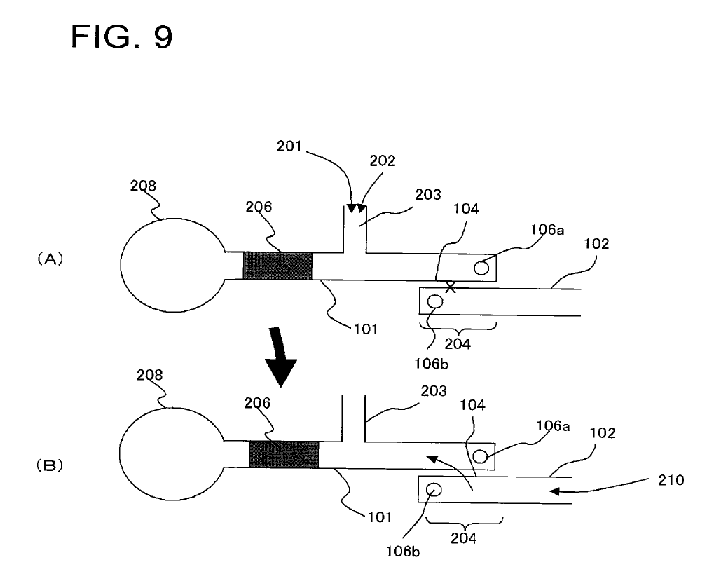

FIGS. 9(A) and (B) are views illustrating a device having the regulation structure in the present embodiment.

The device in the present embodiment is a device having multiple flow channels and the regulation structure described above.

The device has additionally a separation unit which separates a particular substance in sample solution flowing in the flow channel of the device. The separation unit is not particularly limited as long as it has a substance layer to be adsorbed which selectively adsorbs or binds to a particular substance and can separate the particular substance in sample solution. Examples thereof include columns used in affinity column, affinity gel-filtration chromatography, ion-exchange chromatography, hydrophobic chromatography or reversed-phase chromatography, and the like.

The configuration of the separation unit is not particularly limited, and, in a favorable configuration for example, columnar bodies are formed in a flow channel orderly almost at the same interval, the liquid flows through the space among the columnar bodies, and a substance layer to be adsorbed to the particular substance is formed on the surface of the columnar bodies. According to such a configuration, it is possible to make the specific component in the liquid sample adsorbed or bound selectively to the substance to be adsorbed to the surface of the columnar bodies on the microchip.

Such a columnar body can be prepared, for example, by etching the substrate in a predetermined pattern, but the production method is not particularly limited. The shape of the columnar body may be cylindrical or pseudo-cylindrical, conic circular or elliptical cone, polyangular rod such as triangle rod or square rod, or other cross-sectional shape.

The to-be-adsorbed substance A included in the substance layer to-be-adsorbed and the particular substance A′ are selected from the combination resulting in selective adsorption or binding.

Examples of the combinations include:

(a) ligand and receptor,

(b) antigen and antibody,

(c) enzyme and substrate, enzyme and substrate derivative, or enzyme and inhibitor

(d) sugar and lectin,

(e) DNA (deoxyribonucleic acid) and RNA (ribonucleic acid), or DNA and DNA,

(f) protein and nucleic acid, and

(g) metal and protein.

In each combination, one is a particular substance, and the other is an adsorption substance.

When used as a separation device for separation of a particular substance, the device in the present embodiment is specifically a separation device having a separation unit 206 which separates a particular substance in sample solution, the regulation structure 204 above, an inlet unit 203 introducing the sample solution 201, an inlet unit 203 introducing a washing solution 202, and an inlet unit (not shown in drawing) introducing an eluent liquid for the particular substance, wherein the regulation structure 204 communicates with the separation unit 206 via the first flow channel 101, the inlet unit 203 of sample solution 201 and the inlet unit 203 of washing solution 202 communicate with the first flow channel 101 between the regulation structure 204 and the separation unit 206, and the inlet unit of eluent liquid 210 (FIG. 9(B)) communicates with the regulation structure 204 via the second flow channel 102.

In such a configuration, when there is no solution in the first flow channel 101 or the second flow channel 102, for example, the first liquids, sample and washing solutions, do not flow backward through the regulation structure 204, because the liquid in the opposite flow channel does not permeate the regulation structure 204. In addition, it is possible to separate the particular substance at high accuracy by allowing the separation unit 206 to capture the particular substance in sample solution 201, washing the separation unit 206 with a washing solution, and then, separating the particular substance from the separation unit 206 with an eluent liquid 210.

An affinity column having a receptor protein bound with a coupling agent may be used as the separation unit in the device. A detector unit and a collection unit not shown in the drawing may be installed between the separation unit 206 and the wastewater reservoir 208.

In such a configuration, when a substrate binding to or adsorbing to the receptor protein is present in the affinity column of separation unit 206, it is possible to separate and detect the substrate at high accuracy by making the substance in the sample solution bound or adsorbed to the receptor-protein, washing the affinity column 206 with an adequate washing solution, and then, separating the substrate from the affinity column 206 with an eluent liquid 210 separating the receptor protein and the substrate.

As will be described below, the device in the present embodiment may be configured to perform various chromatographies including affinity chromatography on a microchip. Thus, it is possible to use the device installed in μTAS (Micrototal Analytical System) having the separation unit described above and a sample drying unit drying the separated sample, and to recover the separated sample after drying and subject it to analysis in mass spectrometry or the like.

### Embodiment 9

Hereinafter, the method of washing the affinity column by using the device having the regulation structure will be described with reference to FIG. 9.

The washing method in the present embodiment is a washing method of washing the separation device above, having the steps of introducing a washing solution 201 into the washing-solution inlet unit 203, feeding the washing solution in the first flow channel 101, and washing the separation unit 206 with the washing solution. In such a flow, because the regulation structure has a blocking unit 104 of blocking the first liquid, flow of the first liquid from the first flow channel 101 to the second flow channel 102 is blocked in the blocking unit 104 similarly as described above, when there is no liquid in the second flow channel 102. Thus, the washing solution does not flow backward through the regulation structure 204.

For example, when the affinity column above is used as the separation unit 206, a sample is introduced through the inlet unit 203 as the third flow channel, to make the ligand in sample bind to the affinity column, and then, a washing solution 202 is introduced through the inlet unit 203 after the ligand is bound to the separation unit 206. The washing solution washes the affinity column 206 without backflow through the regulation structure 204. The regulation structure 204 functions then as a so-called check valve.

### Embodiment 10

Hereinafter, the method of separating the particular substance by using the device having the regulation structure will be described with reference to FIG. 9.

The method of separating the particular substance in the present embodiment is a separation method of separating the particular substance by using the separation device above. The method includes a step of introducing a sample solution 201 into the sample-solution inlet unit 203, feeding the sample solution in the first flow channel 101, and thus, allowing the particular substance to be captured by the separation unit 206, a washing step of introducing a washing solution 202 into the washing-solution inlet unit 203, feeding the washing solution in the first flow channel 101, and washing the separation unit 206 with the washing solution, a step of introducing an eluent liquid 210 into the eluent-liquid inlet unit (not shown in the drawing), feeding the eluent liquid 210 into first flow channel 101 via the second flow channel 102 and the regulation structure 204, and separating the particular substance from the separation unit 206.

In such a flow, as described above, when there is no liquid in the second flow channel 102 to the opposite of regulation structure 204, the washing solution 202 does not flow backward through the regulation structure 204. It is also possible to separate the particular substance at high accuracy, by allowing the particular substance in sample solution captured by the separation unit 206, washing the separation unit 206 with the washing solution 202, and then, separating the particular substance with an eluent liquid 210 from the separation unit 206.

As described above, when an eluent liquid 210, for example, a salt solution for extraction of ligand, is introduced into the second flow channel 102 after the affinity column in separation unit 206 is washed, the eluent liquid 210 flows through the regulation structure 204 into the separation unit 206, because there is already the washing solution 202 in the first flow channel 101 in the flowing direction of the eluent liquid 210. In this way, it is possible to separate the particular substance from the separation unit 206 and obtain a desirable separation-extraction result.

In such a configuration, it is possible to make the regulation structure 204 function as a kind of check valve and to separate the particular substance in the separation unit at high accuracy without undesirable mixing of liquids.

### Embodiment 11

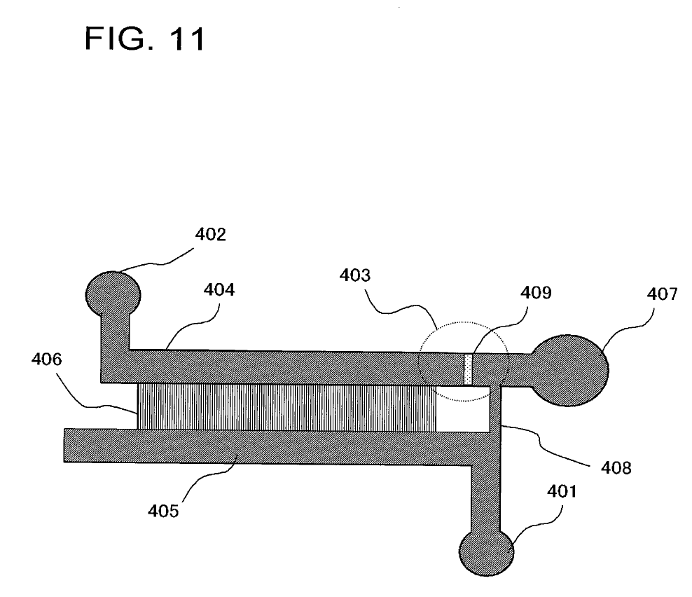

FIG. 11 is a schematic view illustrating the gradient forming device in the present embodiment.

In the present specification, the gradient forming device means a device forming a liquid having a concentration gradient by mixing two or more kinds of liquids. The two or more kinds of liquids are not particularly limited, and for example, may be combination of a salt solution and a buffer solution.

As shown in FIG. 11, the gradient forming device of the present embodiment is a gradient forming device having a forward flow channel 405 in which a first composition solution flows, a backward flow channel 404 in parallel with the forward flow channel 405 in which the second composition solution flows, an first inlet unit 401 communicating with the forward flow channel 405 for introducing the stock solution of first composition solution into the forward flow channel 405, a second inlet unit 402 communicating with the backward flow channel 404 on the downstream side of the forward flow channel 405 for feeding the stock solution of second composition solution into the backward flow channel 404, and a barrier 406 which separates the forward flow channel 405 and the backward flow channel 404 and allows permeation at least of the specific component in the first or second composition solution. Although not shown in the drawing, a gradient solution-collecting unit which communicates with the forward flow channel 405 downstream side of the forward flow channel 405 and collects the first composition solution in which the specific component shows a concentration gradient, may be installed.

In such a configuration, the first and second composition solutions can exchange the components therein while flowing in countercurrent directions. It is thus possible to obtain a gradient solution having a gradient concentration over time without use of an additional special regulation unit.

The gradient forming device may be realized on a microchip where the forward flow channel 405 and the backward flow channel 404 are formed as flow channel grooves formed on the substrate. For example, the gradient forming device in the present embodiment can be prepared by forming grooves of flow channels on the surface of a quartz substrate. The surface of the quartz substrate is generally hydrophilic, and thus, the internal wall of the groove has also a hydrophilic surface.

In the configuration above, the gradient forming device in the present embodiment may be formed on a microchip further with other devices. In addition, it is possible to produce a fine-structured gradient forming device at high accuracy and reduce the size thereof, for example by applying a microfabrication technique used in the technical field of the semiconductor device.

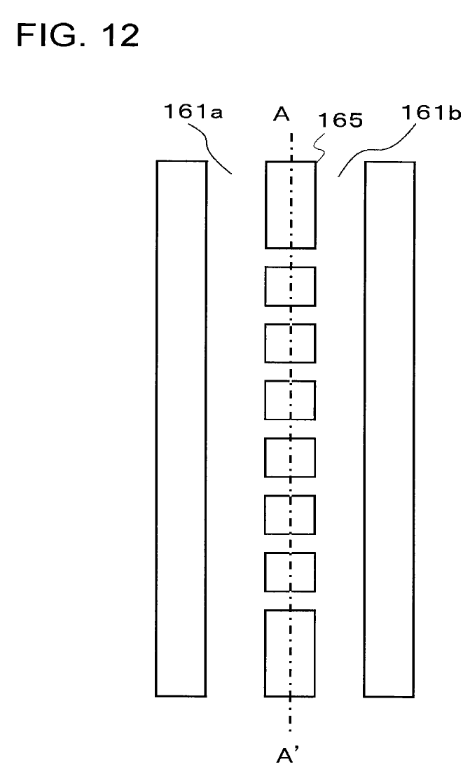

FIG. 12 is an expanded planar view illustrating the configuration of a barrier in the gradient forming device in the present embodiment. As in the drawing, the barrier 165 may have multiple flow channels connecting the forward flow channel 161b and the backward flow channel 161a between them.

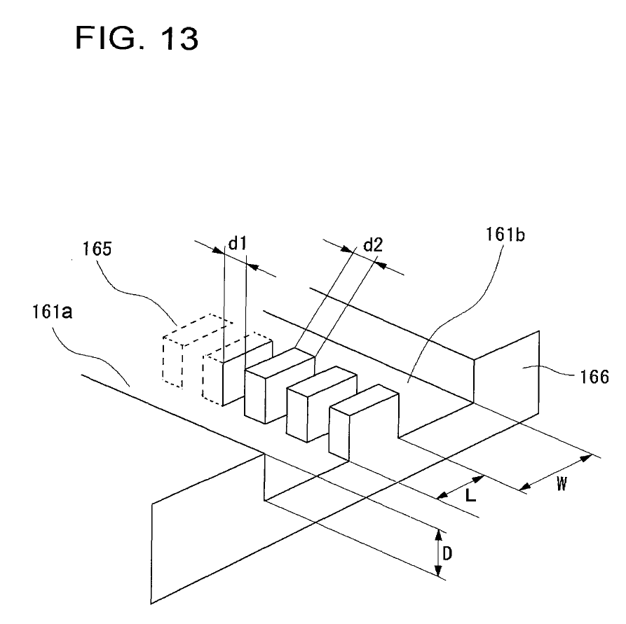

FIG. 13 is a perspective view illustrating the configuration of a barrier in the gradient forming device in the present embodiment. A barrier 165 having multiple flow channels connecting the forward flow channel 161b and the backward flow channel 161a between them, wherein the width of the forward and backward flow channels is W, the length of the barrier is L, the width of the barrier is d2, and the width of multiple flow channels is d1, may be formed on a substrate 166.

It is thus possible for those skilled in the art to adjust the concentration gradient by designing the width and length of the multiple flow channels properly and adjusting the mixing rate of the first and second composition solutions. It is thus possible to obtain a gradient solution having a desirable concentration gradient easily.

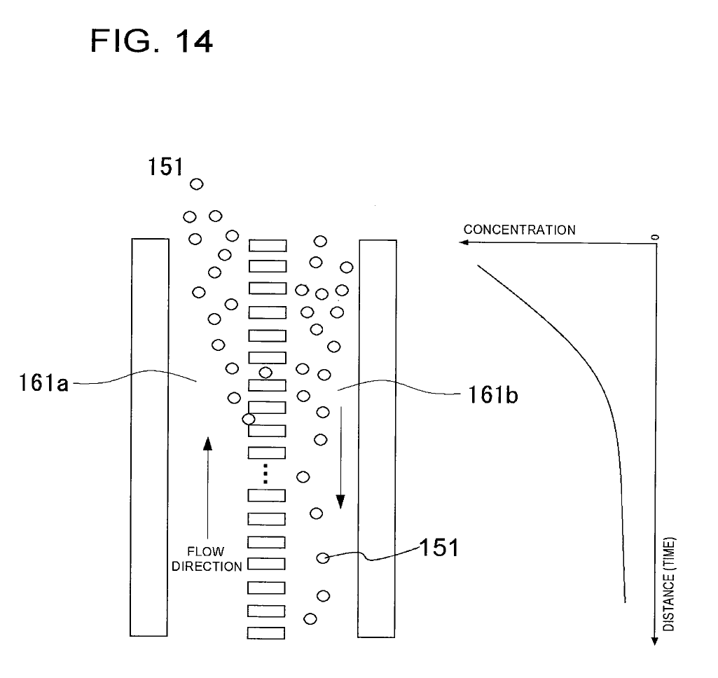

FIG. 14 is a conceptual view illustrating the mechanism of forming a gradient in the gradient forming device having a barrier in the present embodiment shown in FIG. 12.

In the configuration of the barrier 165 having the configuration shown in FIG. 12, part of the particular substance 151 in the forward flow channel 161b enters via the multiple flow channels into the backward flow channel 161a flowing in the countercurrent direction at a predetermined rate, and a gradient solution having a concentration gradient of the particular substance over time or distance is formed in the forward flow channel 161b. It is possible to collect the first composition solution having a gradient, by depleting the second composition solution in the backward flow channel 161a.

The multiple flow channels in barrier may be linear shape in the direction almost perpendicular to the forward or backward flow channel, and one flow channel side is expanded in width than the other flow channel side. Alternatively, the channel may be made of groove tapered in width from one flow channel side to the other flow channel side. In this way, these multiple flow channels in barrier play a role as a check valve for a specific component.

Alternatively, the multiple flow channels in barrier may be formed at an acute angle to the flow direction of the fluid in one flow channel and also at an obtuse angle to the flow direction of the fluid in the other flow channel. The “acute angle to the flow direction of the fluid in one flow channel” means that the angle between the direction of the multiple openings of flow channels toward multiple flow channels formed and the flow direction of the liquid filled in the multiple flow channels (external force-applied direction) is an acute angle. The “obtuse angle to the flow direction of the fluid in one flow channel” means that the angle between the direction of the multiple openings of flow channels toward multiple flow channels formed and the flow direction of the liquid in the flow channels (external force-applied direction) is an obtuse angle. In such a configuration, the multiple flow channels have a function as a check valve and give a gradient solution more favorably.

Alternatively, the barrier is not limited to a configuration having linear multiple flow channels and may have any configuration as long as it has a function as a so-called filtration filter, and for example, the barrier may have multiple small holes. Alternatively, the barrier 406 may have, for example, a configuration in which multiple columnar bodies are placed at a predetermined interval. The space among the columnar bodies constitutes the multiple flow channels. Examples of the shapes of the columnar body include rods such as circular rod, elliptic rod, and pseudocircular rod, cones such as circular cone, elliptic cone, and triangular cone, prisms such as triangular prism, square prism, and the like. The width and length of the multiple flow channels are set properly according to applications.

Such fine multiple flow channels can be formed, for example, by using an electrolithographic method of using a resist for microfabrication. In the present embodiment, the flow channels and the multiple flow channels can be formed on a substrate of silicone substrate, glass substrate such as of quarts, silicone resin substrate, or the like. The flow channels and the multiple flow channels are formed by forming grooves on the surface of the substrate and sealing it with a surface material. The flow channels and the multiple flow channels in the present embodiment can be formed, for example, by etching a substrate in a predetermined pattern, but the preparation method is not particularly limited.

Alternatively, the barrier may be a semipermeable membrane allowing permeation of a specific component. For example, the semipermeable membrane is a membrane allowing exchange of moisture and salt and preparation of a gradient solution, and examples thereof include porous polymeric membranes such as agarose, cellulose, a crosslinked dextran, and polyacrylamide, porous glass, and the like.

Such a configuration results in improvement in the efficiency of the exchange of components between the first and second composition solutions that are flowing in the countercurrent directions, and, for that reason, the gradient solution having a concentration gradient over time or distance has a more uniform concentration gradient. That is, it is possible to prepare a barrier allowing permeation of part or all of the components (for example, salt and moisture) in the first composition solution (for example, salt solution) or the second composition solution (for example, buffer solution) at a suitable permeation rate and to obtain a gradient solution having a concentration gradient over time without use of a special external regulation unit.

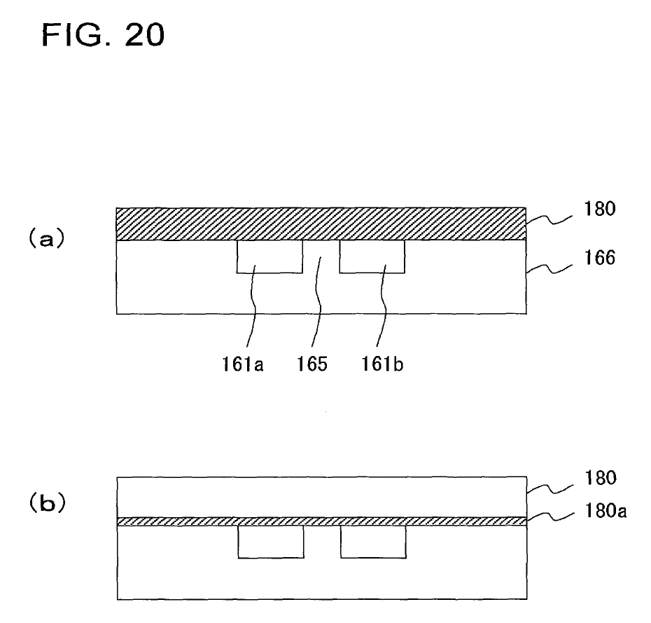

FIG. 20 includes cross-sectional views illustrating the gradient forming devices in the present embodiment.

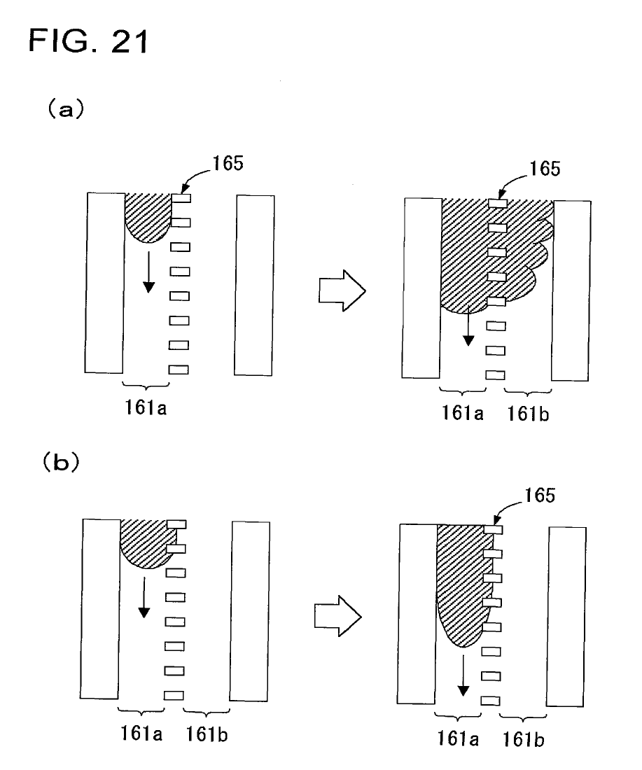

The gradient forming device shown in FIG. 20(a) consists of a substrate 166 including a forward flow channel 161b, a backward flow channel 161a, and a barrier 165 having multiple flow channels, as well as a cover 180. The substrate 166 is the same as that described above, and it is characteristic that a hydrophobic material is used for the cover 180. FIG. 21 is a planar view illustrating the gradient forming device in the present embodiment.

As shown in FIG. 21(a), when a buffer is introduced into the backward flow channel 161a, the buffer permeates rapidly through many openings formed in the barrier 165 into the opposing forward flow channel 161b. It is needed to feed a salt solution into the forward flow channel 161b before such a state is generated, to obtain a favorable gradient. Accordingly, it is necessary to supply the buffer and the salt solution at the same time, but such an operation is usually difficult.

On the other hand, the present inventors have found that the following phenomenon occurred when a hydrophobic material-based cover 180 shown in FIG. 20(a) is used. In FIG. 21(b), when a buffer is introduced into the backward flow channel 161a, the buffer remains in the backward flow channel 161a, without permeating into the opposing forward flow channel 161b. In addition, when, for example, a salt solution is introduced from the opposing forward flow channel 161b in such a state, the liquids in the backward flow channel 161a and the forward flow channel 161b are mixed via the openings formed in the barrier 165, thereby forming a favorable gradient by the effect of the countercurrent flow.

Thus, the gradient forming device shown in FIG. 20(a), eliminates a difficult operation of introducing the buffer and salt solutions simultaneously, thereby forming a favorable gradient reliably.

The material used for the cover 180 of gradient forming device is, for example, a hydrophobic resin such as polydimethylsiloxane (PDMS), polycarbonate, polystyrene, or the like. In addition to the cover 180 using hydrophobic material, for example as shown in FIG. 20(b), a cover carrying a hydrophobic coat layer 180a formed with a hydrophobic coating agent such as xylene silazane on the surface may also be used.

As described in description of the regulation structure shown in FIG. 16, it is necessary to determine the diameter of the openings properly according to the hydrophobicity of the cover 180, in order to form a gradient by liquid mixing through the openings.

Returning to FIG. 11, the gradient forming device in the present embodiment may be a gradient forming device having an additional liquid switch 403 including a blocking unit blocking the second composition solution 409 that is placed in the backward flow channel 404 downstream side of the region in contact with the barrier 406, and a trigger flow channel 408 which communicates with the backward flow channel 404 in the blocking unit 409 or the region downstream side thereof and communicates with the forward flow channel 405 in the first inlet unit 401 or the region downstream side thereof and supplies the first composition solution to the blocking unit 409.

In such a configuration, it is possible to synchronize the timings of initiating flow of the first and second composition solutions. As a result, the efficiency of component exchange between the first and second composition solutions while forming countercurrent flow is increased. The gradient solution having a concentration gradient over time and distance has a more uniform concentration gradient. It is also possible to reduce the amounts of the solution used for gradient formation, for reduction of undesirable discharge of the first and second composition solutions.

Hereinafter, the gradient forming device in the present embodiment which includes a trigger flow channel, is realized on a microchip will be described more specifically with reference to FIG. 11. A case of a gradient solution having a gradually increasing salt concentration will be described below.

The gradient forming device in the present embodiment has the configuration described above and additionally a liquid switch 403. The liquid switch 403 may be in the stand-by state (closed state) or the open state. In the drawing, the trigger flow channel 408 is connected to the side wall of a main flow channel, that is, a buffer flow channel 404.

The trigger flow channel 408 adjusts the flow rate of the liquid in trigger flow channel 408, while, for example, the hydrophilicity of the wall in the trigger flow channel 408 and the diameter of the trigger flow channel 408 are adjusted properly. It is thus possible to adjust the operational speed of the liquid switch 403.

A blocking unit 409 is installed in the upstream side of the intersection region of the buffer flow channel 404 and the trigger flow channel 408 (in the upper right of the drawing). The blocking unit 409 is a region having a greater force by capillary effect than the other regions in the flow channel. Specifically, the blocking unit 409 may have a configuration similar to that in the regulation structures 104 in the embodiments above.

In the closed state of the liquid switch 403, the buffer fed into the buffer flow channel 404 is retained in the blocking unit 409. When a trigger solution, that is, a salt solution, introduced in that state via the trigger flow channel 408 at a desirable timing, the front surface of the salt solution advances and becomes in contact with the blocking unit 409.

In the closed state of the liquid switch 403, the buffer is retained by blocking unit 409 by capillary force, but when the buffer becomes in contact with the salt solution, the buffer moves rightward in the drawing (to downstream side), is fed out to the buffer flow channel 404, then fed into a wastewater reservoir 407. Thus, the salt solution plays a role as priming, prompting the liquid switch 403 to operate.

The first or second composition solution used in the gradient forming device in the present embodiment is a liquid containing predetermined component dissolved or dispersed in a carrier. The carrier is liquid. When the device in the present embodiment is used in preparing a gradient solution as an eluent liquid in affinity chromatography, examples of the carriers for use include pure water, mixtures of pure water and a hydrophilic solvent, buffer solutions, and the like. Specific favorable examples thereof include mixed solution of water and isopropyl alcohol, aqueous solution containing trimethylammonium, boric acid or ethylenediaminetetraacetic acid (EDTA), aqueous sodium phosphate solution, phosphate buffer, physiological saline, and the like.

The gradient forming device in the present embodiment may also have an additional external force-applying unit which applies an external force to the fluid filled in the flow channel. Specific examples of the external force-applying unit include pump, voltage-applying unit, and the like. An external force-applying unit may be installed in each flow channel or in multiple flow channel grooves. When the unit is installed to each flow channel, it is possible to change the flow direction of the fluid in each flow channel freely and also to adjust the countercurrent flow of each fluid. It is thus possible to control the concentration gradient by adjusting mixing rate, and thus, to obtain any mixing efficiency.

Because the liquid in each flow channel migrates spontaneously by force by capillary effect when the channel has an air hole in the present embodiment, it is possible to obtain a gradient forming device smaller in size and thickness, by eliminating the external force-applying unit.

A gradient forming device in which linear flow channels are formed in parallel with each other is described in the present embodiment but the flow channel in the device according to the present invention is not limited to the linear flow channel, and various flow channels different in shape may be employed.

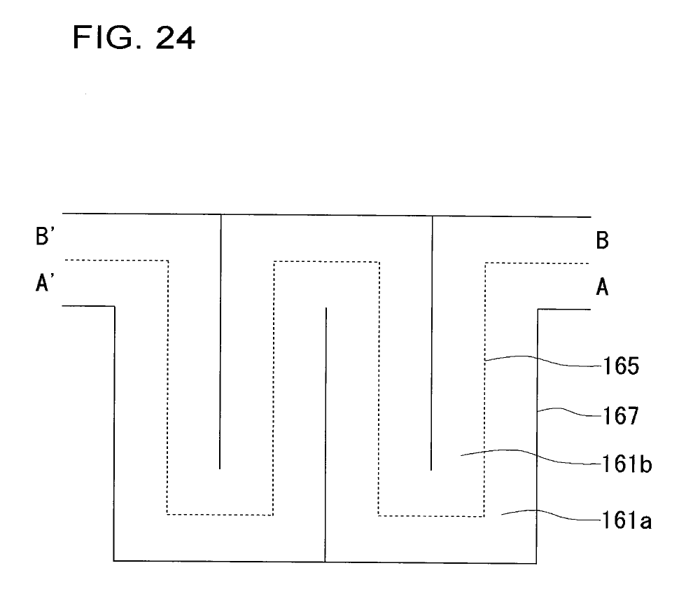

FIG. 24 is a view illustrating an example of the configuration of the forward and backward flow channels in the gradient forming device in the present embodiment.

The countercurrent-generating unit partitioned by a flow channel wall 167 has a configuration in which the forward flow channel 161b and the backward flow channel 161a in parallel with each other is separated by a barrier 165 allowing permeation at least of the specific component. The backward flow channel 161a has an inlet A and an outlet A′ for buffer, and the forward flow channel 161b has an inlet B′ and an outlet B for salt solution.

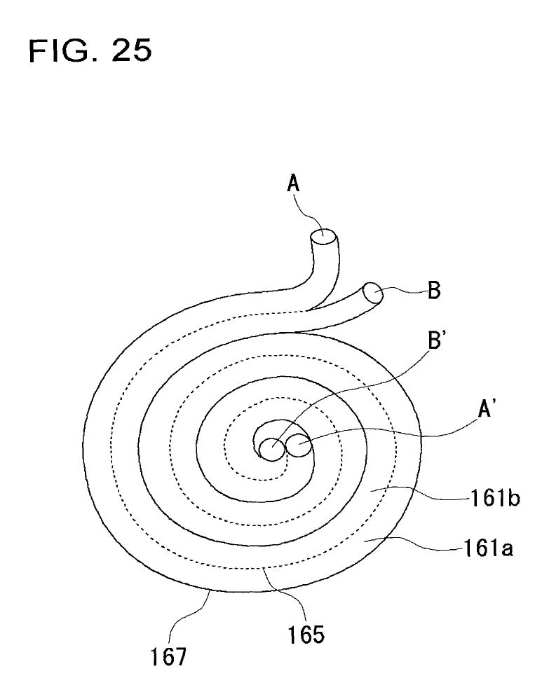

As shown in FIG. 25, the forward and backward flow channels may be formed in spiral.

Even in these configurations, a gradient of the particular substance is formed by countercurrent flow effect, because the forward flow channel 161b and the backward flow channel 161a are formed in parallel as separated by a barrier 165 allowing permeation at least of the specific component. It is also possible to reduce the size of the gradient forming device further in these configurations, because it is possible to expand the surface area of the barrier 165 allowing permeation at least of the specific component.

### Embodiment 12

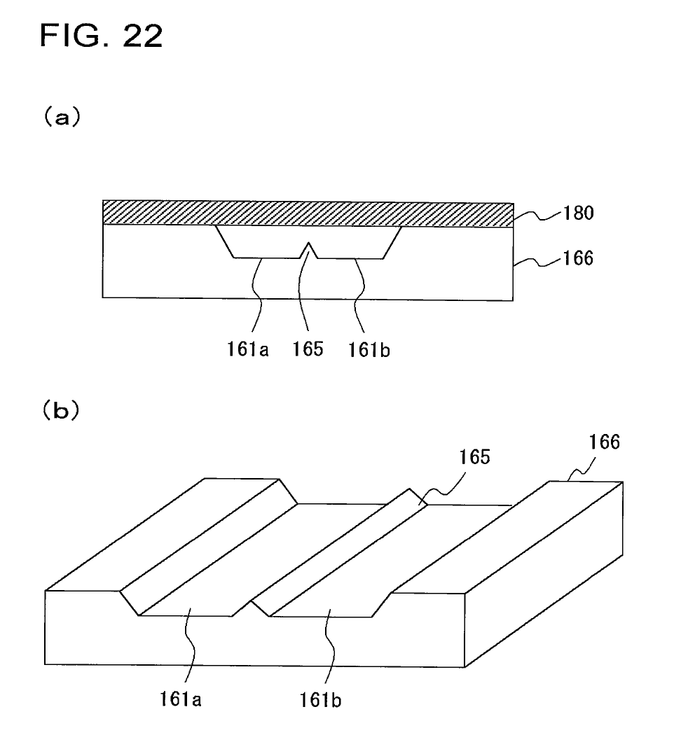

FIG. 22 is a schematic view illustrating the configuration of a barrier in the gradient forming device in the present embodiment.

Gradient forming devices having multiple flow channels have been described in the embodiments above. An example of the gradient forming device different therefrom will be described in the present embodiment.

Specifically, FIGS. 22(a) and (b) are respectively the cross-sectional and perspective views of the device. As shown in FIG. 22(a), a forward flow channel 161b and a backward flow channel 116 are formed on a substrate 166, a bank unit (barrier) 165 so as to separate the channels is formed, and the height of the bank unit is smaller than the depth of the forward and backward flow channels. In addition, a cover 180 is placed on the substrate 166. The cover 180 is not shown in FIG. 22(b) for convenience.

As apparent from FIG. 22(a), there is a space between the barrier 165 and the cover 180, and the forward flow channel 161b and the backward flow channel 161a communicate with each other through the space. The space corresponds to the multiple flow channels formed in the barrier in the gradient forming devices above. Thus, it is possible to form a gradient, for example, by introducing a buffer into the backward flow channel 161a and a salt solution into the forward flow channel 161b. In such a case, a hydrophobic material such as polydimethylsiloxane or polycarbonate may be used as the material for the cover 180. It is possible in this way to supply a buffer or salt solution into a flow channel without undesirable flow into another flow channel. It is also possible to make the liquids in the forward flow channel 161b and backward flow channel 161a mix with each other through the space above and thus form a gradient, as the liquids are filled in both flow channels. It is also possible to obtain such an advantageous effect, even in operation without use of the cover 180 provided. It seems that air functions as a hydrophobic substance, similarly to the cover 180 above.

In the gradient forming device in the present embodiment, the forward flow channel 161b and the backward flow channel 161a are connected to each other through an area wider than that in the gradient forming device of embodiment 11. Thus advantageously, it is possible to form a smoother gradient. In addition, rod-shaped substances are less likely to cause clogging and can migrate between flow channels easily. Accordingly, the device can be used favorably for formation of a gradient containing such a particular substance.

The forward flow channel 161b, backward flow channel 161a and barrier 165 can be prepared, for example, by wet etching of a (100) Si substrate. When a (100) Si substrate is used, the etching progresses in the trapezoidal shape in the direction perpendicular to or parallel with the (001) direction, as shown in the drawing. It is thus possible to regulate the height of the barrier 165 by adjusting the etching period.

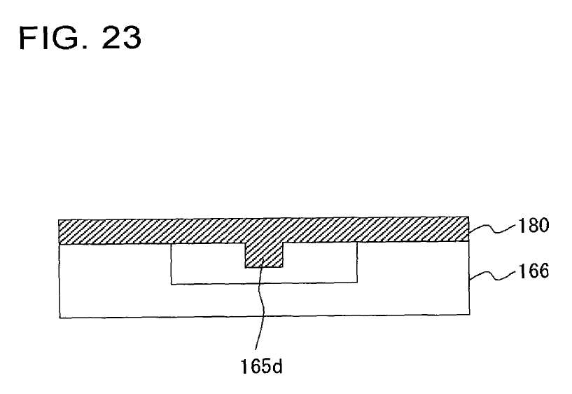

Alternatively, a barrier 165d may be formed on the cover 180, as shown in FIG. 23. The cover 180 having a barrier 165d is easily prepared by injection molding of a resin such as polystyrene. In addition, only one flow channel is formed on the substrate 166, for example, by etching. Accordingly, such a separation device, which can be prepared in the simple process described above, is suitable for mass production.

### Embodiment 13

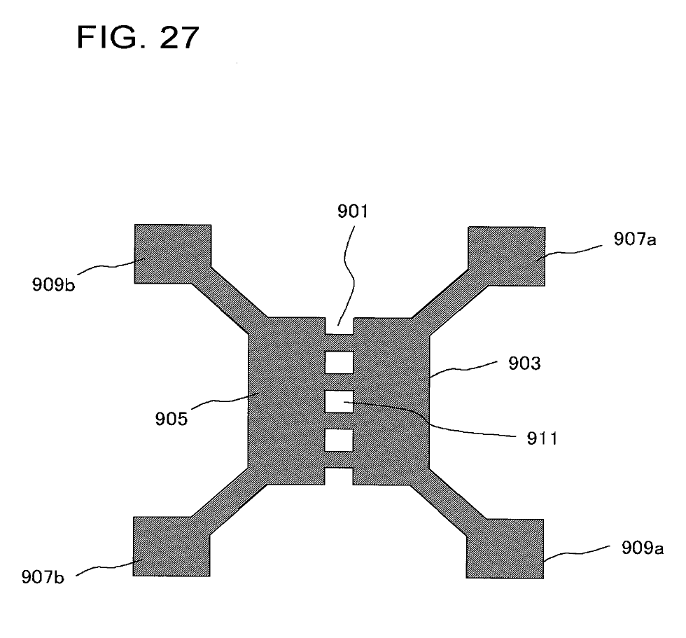

FIG. 27 is a schematic view illustrating the configuration of a barrier in the gradient forming device in the present embodiment.

The barrier in the gradient forming device in the present embodiment can also be prepared by applying a photolithographic technique, similarly to the regulation structure in the present embodiment.

Specifically, it is possible to form the barrier in the gradient forming device in the present embodiment, by applying a highly hydrophobic photoresist, a photocuring resin, or the like on a highly hydrophilic substrate such as slide glass and forming a pattern like that shown in FIG. 27.

For example, Microposit® S1805 photoresist (manufactured by Shipley Company, Inc.) may be used as the photoresist, similarly to the regulation structure in the present embodiment.

The shaded regions in FIG. 27 are hydrophilic regions (S1805-nonapplied or S1805-deleted glass substrate surfaces) that form the flow channels for aqueous solutions. The other regions are hydrophobic regions (S1805-coated surfaces, outer regions not shown) that form the outer wall of the aqueous-solution flow channels and the blocking unit.

Specifically, the barrier 901 in the gradient forming device separating the forward flow channel 903 and the backward flow channel 905 has hydrophobic regions 911 allowing permeation at least of the specific component in the first or second composition solution, and also multiple flow channels allowing communication between the forward flow channel 903 and backward flow channel 905. The multiple flow channels are held between the hydrophobic regions 911. FIG. 27 also shows first and second reservoir units 907a and 907b for introduction of respective composition solutions and wastewater reservoirs 909a and 909b for storing the composition solutions discharged from respective flow channels.

In the configuration too, the forward flow channel 903 and backward flow channel 905 are formed in parallel with each other as separated by the barrier 901 allowing permeation at least of the specific component. Thus, a gradient of particular substance is formed also by countercurrent flow.

The aqueous solution does not permeate into the surface of the hydrophobic region 911. Thus, air bubbles are formed, and the air bubbles form a barrier 901 having multiple flow channels. It is possible to regulate the meniscus size of the air bubbles and the mixing rate of the first and second composition solutions, by properly selecting the size of the hydrophobic region 911 and the kind of the hydrophobic-surfaced material.

These planar structures above are those for processing aqueous solutions, but the barrier in the gradient forming device in the present embodiment is not limited to processing of an aqueous solution. If the first liquid contains, for example, an oily solvent, it is possible to obtain a similar advantageous effect by replacing the hydrophilic region in the planar structures above with a lipophilicity region and the hydrophobic region with a lipophobic region for use.

### Embodiment 14

Hereinafter, the gradient-forming method in the present embodiment will be described with reference to the description of the gradient forming device in the embodiment 11 shown in FIG. 11.

The gradient-forming method in the present embodiment is a method of forming a liquid in which a specific component shows a concentration gradient in the gradient forming device, including a step of introducing the stock solution of a second composition solution into the second inlet unit 402, a step of introducing the stock solution of a first composition solution into the first inlet unit 401, and a step of collecting the first composition solution in which the specific component shows a concentration gradient from the gradient solution-collecting unit.

The gradient-forming method by using the gradient forming device in the present embodiment will be described more specifically below, taking as an example the case where a gradient solution of a salt being a specific component is formed by using the stock solution of a salt solution as the first composition solution and the stock solution of a buffer as the second composition solution.

For example when a buffer is filled in the second inlet unit 402 as buffer tank, the buffer advances to the region of liquid switch 403 by the capillary effect and stays there, while the other buffer remains in the second inlet unit 402.

A salt solution in an amount sufficiently more than the previously filled buffer is then introduced into the first inlet unit 401 as solution inlet unit. The salt solution advances in the forward flow channel 405 as gradient flow channel and also in the trigger flow channel 408 of the liquid switch 403, turning on the liquid switch 403, and advances in the backward flow channel 404 as buffer flow channel into the wastewater reservoir 407. In this way, the buffer in the second inlet unit 402 flows in the direction toward the wastewater reservoir 407, that is, in the direction opposite to the flow of the salt solution (countercurrent direction).

During counterflow of the salt solution and the buffer, the salt in the salt solution spreads into the backward flow channel 404 through the flow channels in barrier 406 having multiple flow channels and water in the other buffer permeates into the salt solution. Therefore a gradient solution is generated in the forward flow channel 405. The gradient solution has a concentration gradient in which salt concentration thereof is lower in the solution closer to the head advancing in the forward flow channel 405, and salt concentration thereof is higher in the solution closer to the first inlet unit 401 to which the salt solution is introduced. It is possible to generate a gradient solution, in which salt concentration is lower in the solution closer to the first inlet unit 401, in the forward flow channel 405, if the first and second composition solutions is exchanged with each other.

When the buffer in the second inlet unit 402 is depleted and the buffer flow is terminated, the countercurrent effect disappears. A solution having the salt concentration gradient retained above is fed out of the tip of the forward flow channel 405, as it is pushed by the flow of the salt solution introduced from the first inlet unit 401 in an amount larger than that of the buffer.

As described above, the barrier 406 above does not allow permeation of a liquid into the opposite side of the barrier 406, when a liquid is filled only in one flow channel of the barrier 406. Accordingly, the gradient solution formed in the forward flow channel 405 is not lost by flow into the backward flow channel 404.

As a result of the flow, the salt concentrations in the salt solution and the buffer differ from each other. Thus, the salt and water are exchanged via the barrier, allowing favorable preparation of the gradient solution. A greater difference in salt concentration leads to a greater gradient inclination, and the difference in salt concentration may be adjusted as needed.

In such a flow, the countercurrent effect disappears, when the buffer in the second inlet unit 402 is depleted and the buffer flow is terminated. Thus, the gradient solution is pushed by the flow of the salt solution introduced from the first inlet unit 401 in a greater amount than the buffer. Thus, the solution having the salt concentration gradient retained above is introduced out of the gradient solution-collecting unit at the end of the forward flow channel 405.

### Embodiment 15

The microchip in the present embodiment may be a microchip having a substrate, the above separation device above formed on the substrate, and the above gradient forming device formed on the substrate, wherein the gradient solution-collecting unit included in the gradient forming device communicates with the eluent-liquid inlet unit in the separation device.

In such a configuration, the microchip in the present embodiment has the functions of the separation device and the gradient forming device on a single chip. Thus, it is possible to perform chromatography using a gradient solution as eluent liquid on a single chip.

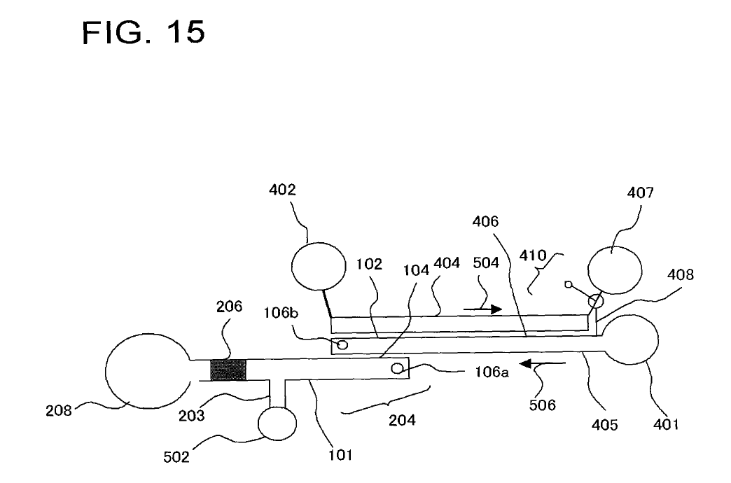

FIG. 15 is a schematic view of such an affinity chromatography device shown as an example of the microchip in the present embodiment.

Specifically, the affinity chromatography device has a first flow channel 101 and a second flow channel 102 communicating with each other via a regulation structure 204. The regulation structure 204 also has a blocking unit 104 between the first flow channel 101 and the second flow channel 102, the first flow channel 101 has a first opening 106 having an air hole at the tip, and the second flow channel 102 has a second opening 106b having an air hole at the tip.

In addition, a separation unit 206 of affinity column is formed in the first flow channel 101, and a wastewater reservoir 208 in the downstream side of the separation unit 206. Additionally, in the midway of the first flow channel 101, a third flow channel 203 is formed at a position sandwiched between the regulation structure 204 and the separation unit 206. And at the tip thereof, a sample and washing-solution inlet unit 502 is formed.

The second flow channel 102 in the affinity-chromatography device communicates similarly with the forward flow channel 405 which is a gradient flow channel in the gradient forming device formed on the microchip in the present embodiment. The forward flow channel 405 is placed in the flow direction 506 of the gradient solution, and a first inlet unit 401 is formed at the initial point of the forward flow channel 405 as a solution inlet unit. A backward flow channel 404 as buffer flow channel is formed almost in parallel with the forward flow channel 405, and the forward flow channel 405 and the backward flow channel 404 are separated by a barrier 406 allowing permeation of part or all of the components in the gradient and buffer solutions. The barrier has, for example, a filtration filter, as described above.

The buffer solution flows in the backward flow channel 404 in the flow direction 504 opposite to the flow direction 506 in the forward flow channel 405. A second inlet unit 402 as buffer tank is formed at the initial point of the backward flow channel 404 and a wastewater reservoir 407 at the end of the backward flow channel 404. A liquid switch 410 is formed before the wastewater reservoir 407 in the downstream side of the backward flow channel 404, the trigger flow channel 408 of the liquid switch 410 communicates with the area immediately downstream side of the first inlet unit 401 in the forward flow channel 405.

In affinity chromatography by using the microchip in the present embodiment, a sample is first introduced from the sample and washing-solution inlet unit 502 and allowed to react with the separation unit 206 of affinity column. The separation unit 206 made of affinity column is then washed while a washing solution made of buffer is introduced from the same sample and washing-solution inlet unit 502. Because there is no liquid in the second flow channel 102, the washing solution does not flows into the second flow channel 102 communicating with the forward flow channel 405 by the action of the regulation structure 204 functioning as a check valve.

A buffer is then fed from the second inlet unit 402 into the backward flow channel 404. The buffer advances in the backward flow channel 404 and stops in the region of the liquid switch 410. The other buffer introduced remains in the second inlet unit 402.

An eluent liquid, for example a salt solution at high concentration, is fed then from the first inlet unit 401 as the first composition solution. The eluent liquid advances in the forward flow channel 405 and part of it in trigger flow channel 408, thereby opening the backward flow channel 404. A flow in the direction opposite to the eluent liquid advancing in the forward flow channel 405 is generated in the backward flow channel 404 at the same time, forming a salt concentration gradient continuous over time in the liquid in the forward flow channel 405 by countercurrent effect.

When the flow of the buffer remaining in the second inlet unit 402 stops, the eluent liquid having a gradient formed moves through the forward flow channel 405 while retaining most of the concentration gradient and reaches the regulation structure 204. Another buffer solution used previously for washing is present in the first flow channel 101 opposite to the other side of the regulation structure 204. Thus, the gradient solution advances to the separation unit 206 of affinity column without stopping in the regulation structure 204. As a result, the particular substance adsorbed on the affinity column is separated.

Thus if the microchip in the present embodiment is used, when a separation unit 206 of affinity column is formed on a device having the regulation structure 204, the sample and washing solutions do not flow into the gradient forming device. It is possible to supply an eluent liquid made of a gradient solution formed in the gradient forming device, for example, into the separation unit 206 of affinity column, and thus, to perform affinity chromatography on a single microchip.

It is thus possible to perform operations of washing the column and separating the ligand bound to the column simultaneously with eluent liquid after reaction of the sample and the column, which is important for performing affinity chromatography on a single microchip. It is also possible to extract substances in the order of binding strength to the column with lowest one first, by supplying an eluent liquid so as to have a gradually rising concentration in the extraction operation. Therefore, it becomes possible to purify ligands by affinity chromatography on a single microchip.

As described above, the microchip in the present embodiment has a regulation structure needed for prevention of backflow in the washing operation and a gradient forming device forming a concentration gradient of eluent liquid. By achieving affinity chromatography on a microchip, only small amounts of sample and solvent is required and no additional device for generating the gradient is needed. Thus, the microchip in the present embodiment may be used practically in pretreatment for separation of viral antigens from contaminants in diagnosis of infectious disease to improve the test accuracy.

### Embodiment 16

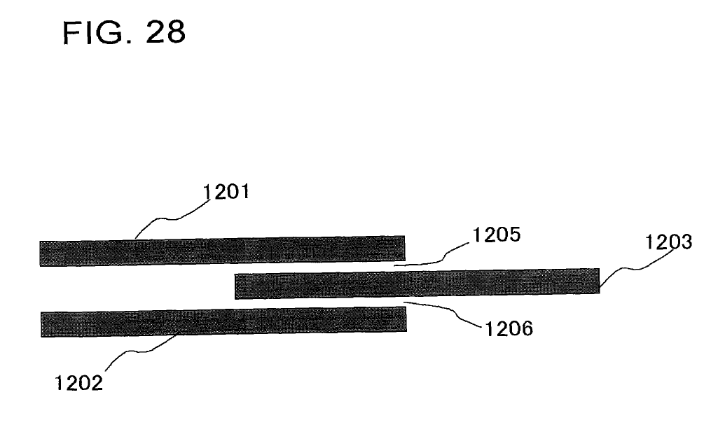

FIG. 28 is a schematic view of a liquid switch used in combination with the regulation structure or gradient forming device according to an embodiment of the present invention.

The liquid switch shown in FIG. 28 can also be prepared by applying a photolithographic technique. Specifically, the liquid switch can be formed by applying a highly hydrophobic photoresist, a photocuring resin, or the like on a highly hydrophilic substrate such as slide glass and forming a pattern similar to that shown in FIG. 28. The shaded regions in FIG. 28 represent hydrophilic regions, and the other external regions hydrophobic regions (outer regions not shown).

As shown in FIG. 28, in the liquid switch, two main flow channels extending horizontally (first flow channel 1201 and second flow channel 1202) cross the trigger flow channel 1203 extending horizontally holding it in-between, thereby forming a first blocking unit 1205 and a second blocking unit 1206 having a hydrophobic region on both sides of the trigger flow channel 1203 and separating the main flow channels.

In such a configuration, the liquid switch have the function of the regulation structure in the present embodiment, in the first flow channel 1201, the first blocking unit 1205 and trigger flow channel 1203, and also in the region of the trigger flow channel 1203, the second blocking unit 1206 and the second flow channel 1202. When an aqueous solution is introduced into the first flow channel 1201, the main flow channel opens, only when there are aqueous solutions in the trigger flow channel 1203 and also in the second flow channel 1202 on the other side. In addition, because three flow channels is formed in parallel, the area of the liquid switch can be made smaller. Therefore, there is an advantage of increasing freedom in designing the liquid switch on the substrate. Such a configuration is also advantageous in reducing the size of the microchip having a liquid switch.

The planar structure is a structure processing aqueous solutions, but the liquid switch in the present embodiment is not particularly limited to regulation of aqueous solutions. If the liquid introduced into the first flow channel contains, for example, an oily solvent, it is possible to obtain a similar advantageous effect by replacing the hydrophilic region with a lipophilicity region in the planar structures and the hydrophobic region with a lipophobic region.

### Embodiment 17

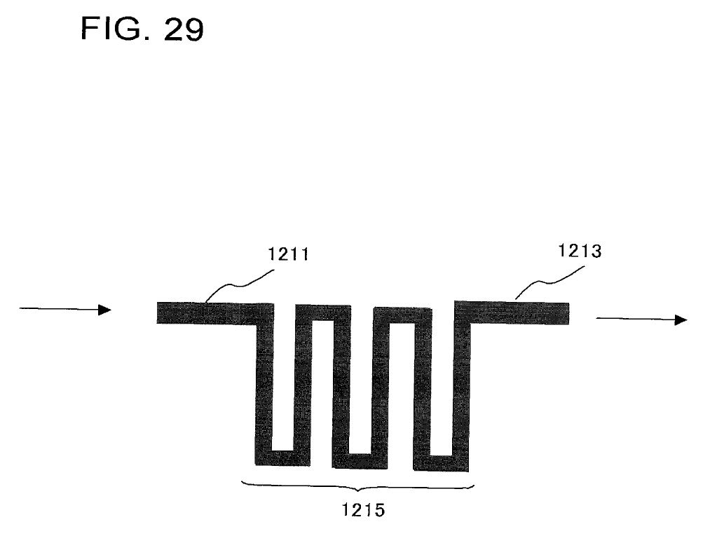

FIG. 29 is a planar view showing a delay device used in combination with the regulation structure or gradient forming device according to an embodiment of the present invention.

The delay device can also be prepared by applying a photolithographic technique. Specifically, the delay device can be formed by applying a highly hydrophobic photoresist, a photocuring resin, or the like on a highly hydrophilic substrate such as slide glass and forming a pattern similar to that shown in FIG. 29. In FIG. 29, the shaded regions represent hydrophilic regions and the other regions hydrophobic regions (outer regions not shown).

The delay device has an inlet channel 1211, an outlet channel 1213, and a delay flow channel 1215, respectively of hydrophilic region. An aqueous solution introduced from the inlet channel 1211 is discharged through the delay flow channel 1215 out of the outlet channel 1213. It is possible to adjust the period of the aqueous solution flowing in the delay flow channel by adjusting the length cross-sectional area and cross-sectional shape of the delay flow channel. It is possible to supply an aqueous solution to the regulation structures and the gradient forming devices described in the embodiments above at a desirable timing, by combined use of the delay device.

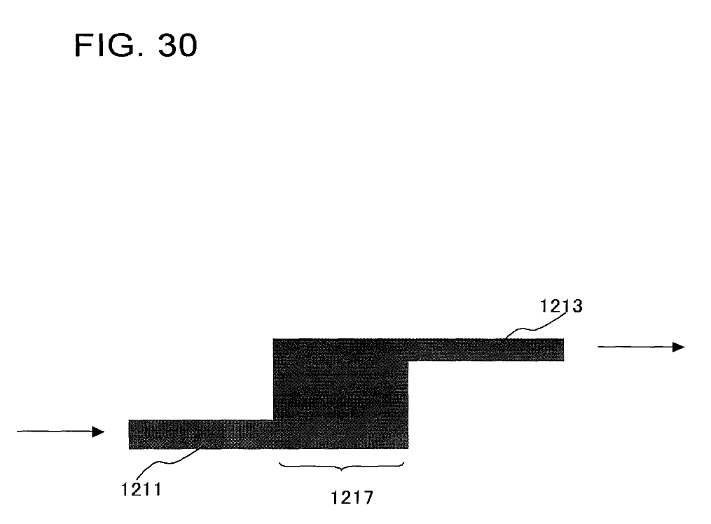

FIG. 30 is a planar view showing a delay device used in combination with the regulation structure or gradient forming device according to an embodiment of the present invention.

The delay device can also be prepared by applying a photolithographic technique. Specifically, the delay device can be formed by applying a highly hydrophobic photoresist, a photocuring resin, or the like on a highly hydrophilic substrate such as slide glass and forming a pattern similar to that shown in FIG. 30. In FIG. 30, the shaded regions represent hydrophilic regions and the other regions hydrophobic regions (outer regions not shown).

The delay device has an inlet channel 1211, an outlet channel 1213, and a delay chamber 1217, respectively of hydrophilic region. An aqueous solution introduced from the inlet channel 1211 is discharged through the delay chamber 1217 out of the outlet channel 1213. It is possible to adjust the period of the aqueous solution flowing in the delay chamber, by adjusting the capacity and shape of the delay chamber. It is possible to supply an aqueous solution to the regulation structures and the gradient forming devices described in the embodiments above at a desirable timing, by combined use of the delay chamber.

The planar structure is a structure processing aqueous solutions, but the delay device in the present embodiment is not particularly limited to control of the passage time of aqueous solution. If the liquid introduced into the inlet channel contains, for example, an oily solvent, it is possible to obtain a similar advantageous effect by replacing the hydrophilic region with a lipophilicity region in the above planer structure and the hydrophobic region with a lipophobic region.

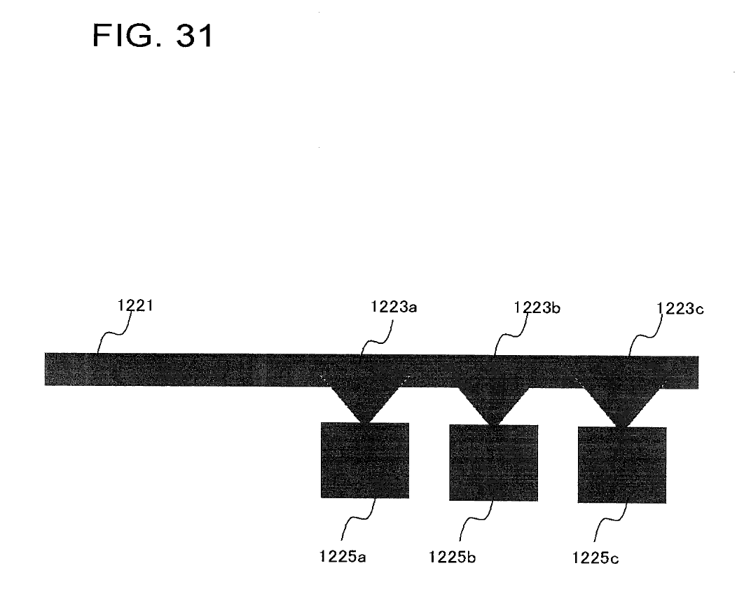

FIG. 31 is a planar view illustrating a fractionating device used in combination with the regulation structure or gradient forming device according to an embodiment of the present invention.

The fractionating device can also be prepared by applying a photolithographic technique. Specifically, the fractionating device is formed by applying a highly hydrophobic photoresist, a photocuring resin, or the like on a highly hydrophilic substrate such as slide glass and forming a pattern similar to that shown in FIG. 31. In FIG. 31, the shaded regions represent hydrophilic regions and the other regions hydrophobic regions (outer regions not shown).

The fractionating device has a main flow channel 1221, fractionating flow channels 1223a, 1223b, and 1223c, and fraction chambers 1225a, 1225b, and 1225c, respectively of hydrophilic region.

An aqueous solution introduced into the main flow channel 1221 of the fractionating device is fractionated respectively through fractionating flow channels 1223a, 1223b, and 1223c into the corresponding fraction chambers 1225a, 1225b, and 1225c.

The passage speed of the aqueous solution declines when the shape of the fractionating flow channels 1223a, 1223b, and 1223c is two small, but, as shown in FIG. 31, the aqueous solution flows smoothly when the cross-sectional area of the fractionating flow channels is made wider at the influx side of the aqueous solution and narrower at the efflux side of the aqueous solution. In the configuration above, it is also possible to prevent backflow of the aqueous solution.

In the fractionating device, an aqueous solution is first fractionated into the fraction chamber 1225a. When the fraction chamber 1225a is filled, the aqueous solution is fractionated into the next fraction chamber 1225b. When the fraction chamber 1225b is filled, the aqueous solution is fractionated into the next fraction chamber 1225c. Thus, an aqueous solution varying in composition over time is fractionated in the fractionating device, thereby fractionating into three aqueous solution fractions different in composition.

In addition, it is possible to perform three kinds of chemical reactions simultaneously in a simple configuration, by using the fraction chambers 1225a, 1225b, and 1225c as reaction chambers, by adding different substances previously thereto.

### Embodiment 18

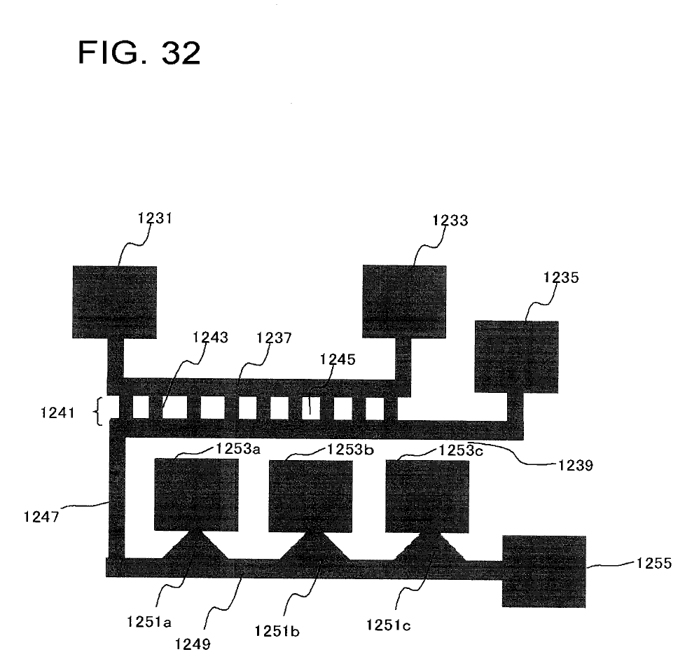

FIG. 32 is a planar view illustrating a structure used in combination with the gradient forming device in the embodiment above, the delay device, and the fractionating device.

The structure can also be prepared by applying a photolithographic technique. Specifically, the structure can be formed by applying a highly hydrophobic photoresist, a photocuring resin, or the like on a highly hydrophilic substrate such as slide glass and forming a pattern similar to that shown in FIG. 32. In FIG. 32, the shaded regions represent hydrophilic regions and the other regions hydrophobic regions (outer regions not shown).

The structure has a second inlet unit 1231 (buffer inlet) introducing a buffer solution as second composition solution, a wastewater reservoir 1233, a first inlet unit 1235 (salt solution inlet) introducing a salt solution containing a salt at high concentration as first composition solution, a backward flow channel 1237 as buffer flow channel, a forward flow channel 1239 as gradient flow channel, a barrier 1241 containing multiple communicating flow channels 1243, and hydrophobic regions 1245 formed among multiple communicating flow channels. It also contains a fractionating device having a main flow channel 1249, fractionating flow channels 1251a, 1251b, and 1251c, fraction chambers 1253a, 1253b, and 1253c, and a wastewater reservoir 1255. In addition, it has a communicating flow channel 1247 allowing communication between the gradient forming device and the fractionating device.

In such a configuration, as described in the embodiments of the gradient forming devices above, a gradient solution is formed in the forward flow channel 1239 while a salt solution is mixed with a buffer solution from the backward flow channel 1237. Then, the gradient solution is fed from the forward flow channel 1239 of the gradient forming device through the communicating flow channel 1247 into the main flow channel 1249 of the fractionating device. The gradient solution fed into the main flow channel 1249 is then fractionated through the fractionating flow channels 1251a, 1251b, and 1251c into the fraction chambers 1253a, 1253b, and 1253c in that order.

As a result, for example, a dilute salt solution is dispensed in the fraction chamber 1253a, a medium-concentration salt solution in the fraction chamber 1253b, and a concentrated salt solution in the fraction chamber 1253c. In such a case, if the same substance is previously placed in the fraction chambers 1253a, 1253b, and 1253c, chemical reactions different according to the concentration of the salt solution progresses in the chambers.

The planar structure described is a structure processing aqueous solutions, but the structure in combination of a gradient forming device and a fractionating device in the present embodiment is not particular limited to passage time of aqueous solutions. Thus, if the liquids introduced into the buffer inlet and the salt solution inlet are changed to those containing, for example, an oily solvent, it is possible to obtain a similar advantageous effect by replacing the hydrophilic region with a lipophilicity region in the planar structure and the hydrophobic region with a lipophobic region.

### Embodiment 19

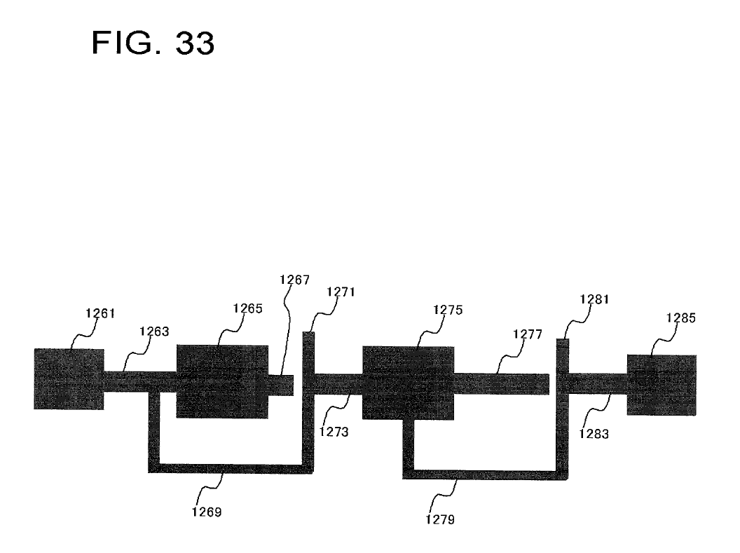

FIG. 33 is a planar view illustrating a timing adjustment device used in combination with the regulation structure or gradient forming device according to an embodiment of the present invention.

The timing adjustment device can also be prepared by applying a photolithographic technique. Specifically, the timing adjustment device can be formed by applying a highly hydrophobic photoresist, a photocuring resin, or the like on a highly hydrophilic substrate such as slide glass and forming a pattern similar to that shown in FIG. 33. In FIG. 33, the shaded regions represent hydrophilic regions and the other regions hydrophobic regions (outer regions not shown).

The timing adjustment device has a sample inlet 1261, a flow channel 1263, a reaction chamber 1265, a flow channel 1267, a timing flow channel 1269, a trigger flow channel 1271, a flow channel 1273, a reaction chamber 1275, a flow channel 1277, a timing flow channel 1279, a timing flow channel 1281, a flow channel 1283, and a wastewater reservoir 1285.

In the configuration, an aqueous solution introduced into the sample inlet 1261 flows through the flow channel 1263 into the reaction chamber 1265, and reaches the end of the flow channel 1267. However, the aqueous solution is then blocked in the hydrophobic region, because there is no aqueous solution in the trigger flow channel 1271 facing the flow channel separated by a hydrophobic region.

When the aqueous solution is introduced continuously into the sample inlet 1261, the reaction chamber 1265 is soon filled, and the aqueous solution flows into the timing flow channel 1269. When the aqueous solution flows into the trigger flow channel 1271 communicating with the timing flow channel 1269, the meniscus of the frontal liquid in the flow channel 1267 becomes in contact with the meniscus of the liquid in the trigger flow channel 1271, opening the liquid switch. As a result, the aqueous solution flows from the flow channel 1267 to the flow channel 1273.

If the aqueous solution is introduced continuously further into the sample inlet 1261, the aqueous solution flows into the reaction chamber 1275 and reaches the end of the flow channel 1277. However, the aqueous solution is blocked then in the hydrophobic region, because there is no aqueous solution in the trigger flow channel 1281 facing the flow channel separated by the hydrophobic region.

If the aqueous solution is introduced further into the sample inlet 1261, the reaction chamber 1275 is soon filled, and the aqueous solution flows into the timing flow channel 1279. When the aqueous solution flows into the trigger flow channel 1281 communicating with the timing flow channel 1279, the meniscus of the frontal liquid in the flow channel 1277 becomes in contact with that of the liquid in the trigger flow channel 1281, thereby opening the liquid switch. As a result, the aqueous solution flows from the flow channel 1277 into the flow channel 1283. The aqueous solution entering into the flow channel 1283 further flows into the wastewater reservoir 1285.

In this way, it is possible to adjust the timing of feeding the aqueous solution from the reaction chamber to the next reaction chamber by using the timing adjustment device in the present embodiment. Advantageously, it is possible to control the period of chemical reaction in the reaction chamber easily.

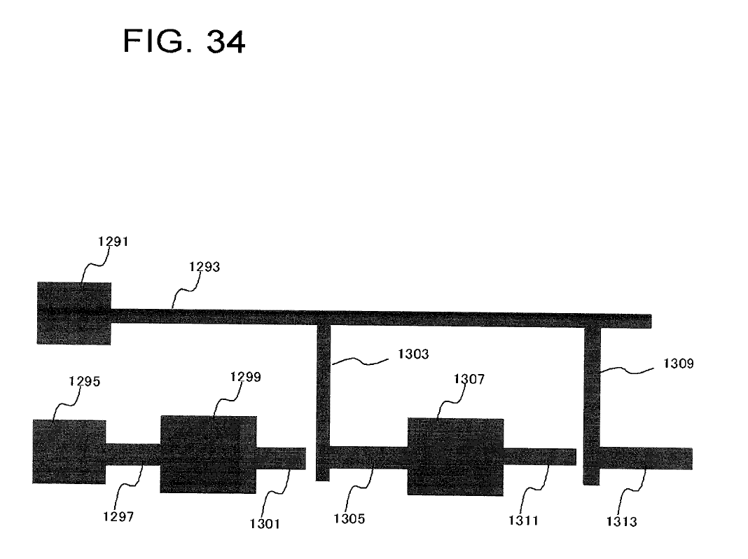

FIG. 34 is a planar view illustrating a modification of the timing adjustment device used in combination with the regulation structure or the gradient forming device in the present embodiment.

The timing adjustment device can also be prepared by applying a photolithographic technique. Specifically, the timing adjustment device can be formed by applying a highly hydrophobic photoresist, a photocuring resin, or the like on a highly hydrophilic substrate such as slide glass and forming a pattern similar to that shown in FIG. 34. In FIG. 34, the shaded regions represent hydrophilic regions and the other regions hydrophobic regions (outer regions not shown).

The timing adjustment device has a sample inlet 1291, a flow channel 1293, a sample inlet 1295, a timing flow channel 1297, a reaction chamber 1299, a flow channel 1301, a trigger flow channel 1303, a flow channel 1305, a reaction chamber 1307, a flow channel 1311, a timing flow channel 1309, and a flow channel 1313.

In the configuration, the aqueous solution introduced into the sample inlet 1295 flows through the flow channel 1297 into the reaction chamber 1299 and reaches the end of the flow channel 1301. However, the aqueous solution is blocked then in the hydrophobic region, because there is no aqueous solution in the trigger flow channel 1303 facing the flow channel separated by a hydrophobic region.

When an aqueous solution is introduced into the sample inlet 1291, the aqueous solution flows through the timing flow channel 1293 into the trigger flow channel 1303. The meniscus of the liquid in the flow channel 1301 becomes in contact with that of the liquid in the trigger flow channel 1303, thereby opening the liquid switch. As a result, the aqueous solution flows from the flow channel 1301 into the flow channel 1305.

When the aqueous solution is introduced continuously into the sample inlet 1295, the aqueous solution flows into the reaction chamber 1307 and reaches the end of the flow channel 1311. However, the aqueous solution is blocked then in the hydrophobic region, because there is no aqueous solution in the trigger flow channel 1309 facing the flow channel separated by a hydrophobic region.

When the aqueous solution is introduced further into the sample inlet 1291, the aqueous solution flows through the timing flow channel 1293 into the trigger flow channel 1309. The meniscus of the liquid in the flow channel 1311 becomes in contact with that of the liquid in the trigger flow channel 1309, thereby opening the liquid switch. As a result, the aqueous solution flows from the flow channel 1311 into the flow channel 1313.

In this manner, by using the timing adjustment device in the present embodiment, it is possible to adjust, for example, the timing of feeding the aqueous solution from the reaction chamber to the next reaction chamber synchronous with the timing of feeding the aqueous solution into the sample inlet 1291. Advantageously, it is thus possible to control the period of chemical reaction in a reaction chamber easily.

The planar structure is a structure processing aqueous solutions, but the timing adjustment device in the present embodiment is not particularly limited to regulation of the passage time of the aqueous solution. If the liquid introduced into the sample inlet is changed to a liquid containing, for example, an oily solvent, it is possible to obtain a similar advantageous effect by replacing the hydrophilic region with a lipophilicity region and the hydrophobic region with a lipophobic region.

Favorable embodiments of the present invention were so far described, but combinations of any of these configurations are also included in the aspects of the present invention. In addition, conversions of expressions according to the present invention into other categories are also effective as aspects of the present invention.

1. A regulation structure, comprising:
a first flow channel in which a first liquid flows;
a blocking unit which communicates with said first flow channel and blocks said first liquid; and
a second flow channel introducing a second liquid to said blocking unit,
which regulates the flow of said first liquid from said first flow channel to said second flow channel.

2. A regulation structure, comprising:
a first flow channel;
a second flow channel;
a communication unit communicating with these flow channels; and
a blocking unit which is formed in said communication unit and blocks flow of said first liquid from said first flow channel to said second flow channel,
wherein said blocking unit regulates flow of said first liquid from said first flow channel to said second flow channel when there is no liquid in said second flow channel, and allows flow between said first flow channel and said second flow channel when there is a liquid in said second flow channel.

3. The regulation structure according to claim 1,
wherein said first flow channel and said second flow channel are placed in parallel with each other in the region close to said blocking unit.

4. The regulation structure according to claim 1,
wherein said first flow channel and said second flow channel are flow-channel grooves formed on a single substrate.

5. The regulation structure according to claim 1,
wherein said blocking unit has a region more lyophobic to said first liquid than said first flow channel.

6. The regulation structure according to claim 1,
wherein the blocking unit has a surface area per unit volume larger than that of said first flow channel.

7. The regulation structure according to claim 1,
wherein said blocking unit has multiple communicating flow channels formed in a barrier separating said first flow channel and said second flow channel.

8. The regulation structure according to claim 1,
wherein said blocking unit has a porous material.

9. The regulation structure according claim 1,
wherein said blocking unit has a single or multiple projections.

10. The regulation structure according claim 1,
wherein said first flow channel has a first opening communicating with the external atmosphere, and
said second flow channel has a second opening communicating with the external atmosphere.

11. A separation device, comprising:
a separation unit which separates a particular substance in a sample solution;
the regulation structure described in claim 1;
an inlet unit for said sample-solution;
an inlet unit for a washing-solution; and
an inlet unit for an eluent liquid for said particular substance,
wherein said regulation structure communicates with said separation unit via said first flow channel,
said sample-solution inlet unit and said washing-solution inlet unit communicate with said first flow channel between said regulation structure and said separation unit, and
said eluent-liquid inlet unit communicates with said regulation structure via said second flow channel.

12. A gradient forming device, comprising:
a forward flow channel in which a first composition solution flows;
a backward flow channel placed in parallel with said forward flow channel in which a second composition solution flows;
a first inlet unit which communicates with said forward flow channel and introduces the stock solution of said first composition solution into said forward flow channel;
a second inlet unit which communicates with said backward flow channel in the downstream side of said forward flow channel and supplies the stock solution of said second composition solution into said backward flow channel; and
a barrier which separates said forward and backward flow channels and allows permeation at least of said specific component in said first composition solution or said second composition solution.

13. The gradient forming device according to claim 12,
wherein said forward flow channel and said backward flow channel are flow-channel grooves formed on a single substrate.

14. The gradient forming device according to claim 12,
wherein said barrier has multiple flow channels communicating with said forward flow channel and said backward flow channel.

15. The gradient forming device according to claim
wherein said barrier is made of a membrane allowing permeation at least of said specific component.

16. The gradient forming device according to claim 12, further comprising a liquid switch having a blocking unit which is provided in said backward flow channel at downstream side of the region in contact with said barrier and blocks said second composition solution and a trigger flow channel which communicates with said backward flow channel in said blocking unit or the region downstream side thereof and communicates with said forward flow channel in said first inlet unit or the region downstream side thereof and introduces said first composition solution to said blocking unit.

17. A microchip, comprising a substrate, said separation device according to claim 11 formed on said substrate, and a gradient forming device formed on said substrate,
wherein said gradient forming device includes:
a forward flow channel in which a first composition solution flows;
a backward flow channel placed in parallel with said forward flow channel in which a second composition solution flows;
a first inlet unit which communicates with said forward flow channel and introduces the stock solution of said first composition solution into said forward flow channel;
a second inlet unit which communicates with said backward flow channel in the downstream side of said forward flow channel and supplies the stock solution of said second composition solution into said backward flow channel; and
a barrier which separates said forward flow channel and said backward flow channel and allows permeation at least of the specific component in said first composition solution or said second composition solution, and
wherein said gradient solution-collecting unit communicates with said eluent-liquid inlet unit included in said separation device.

18. A mass spectrometric system, comprising
a separation unit which separates a biological sample according to the molecule size or the property thereof,
a pretreatment unit which performs pretreatments including enzyme digestion treatment of the sample separated by said separation unit,
a drying unit which dries the pretreated sample, and
a mass spectrometric unit which analyzes the dried sample by mass spectrometry,
wherein said separation unit includes the microchip according to claim 17.
